(19) United States
(12) Patent Application Publication
(10) Pub. No.: US 2026/0292829 A1
(43) Pub. Date: Sep. 24, 2026

(54) INFORMATION TRANSMISSION METHOD, AND COMMUNICATION DEVICE

(71) Applicant: BEIJING XIAOMI MOBILE SOFTWARE CO., LTD., Beijing (CN)

(72) Inventor: Shengxiang GUO, Beijing (CN)

(21) Appl. No.: 19/469,533

(22) PCT Filed: Mar. 31, 2023
(86) PCT No.: PCT/CN2023/085783

§ 371 Date: Sep. 26, 2025

(51) Int. Cl. H04W 72/21; H04W 72/115

(52) U.S. Cl. CPC H04W 72/21; H04W 72/115

(57) ABSTRACT

An information transmission method, performed by a terminal, includes: sending first information to a network device, in which, the first information includes a first indicator, and the first indicator indicates one or more usage cases of one or more transmission occasions (TOs). An information transmission method, performed by a network device, includes: receiving first information sent by a terminal, in which, the first information includes a first indicator, and the first indicator indicates one or more usage cases of one or more TOs.

### CROSS REFERENCE TO RELATED APPLICATIONS

This application is a US national phase application based on International Application No. PCT/CN2023/085783, filed on Mar. 31, 2023, the entire content of which is incorporated by reference.

### TECHNICAL FIELD

The disclosure relates to the field of mobile communication technology, in particular to an information transmission method, and a communication device.

### BACKGROUND

In a mobile communication system, a network device generally configures a configured grant (CG) period for a terminal, and the CG period may include a plurality of transmission occasions (TOs). In an example, the terminal may select at least a part of the TOs in the CG period for uplink transmission. However, a TO unused by the terminal may be idle, which may result in a waste of resources. In addition, for the TO unused by the terminal, the network device may still be monitoring the TO, which may result in an additional overhead of the resources.

### SUMMARY

In a first aspect, embodiments of the present disclosure provide an information transmission method. The method includes: sending first information to a network device, in which, the first information includes a first indicator, and the first indicator is used to indicate one or more usage cases of one or more transmission occasions (TOs).

In a second aspect, embodiments of the present disclosure provide an information transmission method. The method includes: receiving first information sent by a terminal, in which, the first information includes a first indicator, and the first indicator is used to indicate one or more usage cases of one or more transmission occasions (TOs).

In a third aspect, embodiments of the present disclosure provide a first information transmission apparatus. The first information transmission apparatus includes one or more processors, configured to send first information to a network device, in which, the first information includes a first indicator, and the first indicator is used to indicate one or more usage cases of one or more transmission occasions (TOs).

### BRIEF DESCRIPTION OF THE DRAWINGS

The above and/or additional aspects and advantages of the present disclosure will become apparent and readily understood from the following description of embodiments in combination with the accompanying drawings, in which:

FIG. 1 is a structural diagram of a communication system provided by an embodiment of the disclosure.

FIGS. 2a-2c, 2d1, 2e1, and 2f-2h are interactive schematic diagrams of an information transmission method performed by a terminal provided by an embodiment of the present disclosure.

FIG. 2d2 and FIG. 2e2 are schematic diagrams of sending first information according to an embodiment of the present disclosure.

FIGS. 3a-3g are flowcharts of an information transmission method performed by a network device provided by an embodiment of the present disclosure.

FIG. 4 is a flowchart of an information transmission method provided by an embodiment of the present disclosure.

FIG. 5a is a structural schematic diagram of a first information transmission apparatus provided by an embodiment of the disclosure.

FIG. 5b is a structural schematic diagram of a second information transmission apparatus provided by another embodiment of the disclosure.

FIG. 6a is a structural schematic diagram of a communication device provided by an embodiment of the disclosure.

FIG. 6b is a structural schematic diagram of a chip provided by another embodiment of the disclosure.

### DETAILED DESCRIPTION

A method in the present disclosure may be used by a terminal to indicate a usage case of a TO in a CG period to a network device, such that the network device may reuse an unused TO for other uplink transmitting, thereby ensuring an efficiency of uplink transmitting.

The present disclosure provides an information transmission method, an information transmission apparatus, and a communication device, a communication system and a storage medium.

In a first aspect, embodiments of the present disclosure provide an information transmission method. The method includes: sending first information to a network device, in which, the first information includes a first indicator, and the first indicator is used to indicate one or more usage cases of one or more transmission occasions (TOs).

In the above embodiment, the terminal may send the first information to the network device, to indicate the usage case of the TO by the terminal to the network device, thereby achieving a successful indication of the usage case of the TO and ensuring that the network device can know the usage case of the TO by the terminal. Therefore, the network device can schedule an unused TO of the terminal to be reused for uplink transmitting of other terminals, avoiding idleness of resources and ensuring an efficiency of uplink transmitting.

In combination with some embodiments of the first aspect, in some embodiments, the TO includes at least one of: a TO in a CG period configured by the network device to the terminal device based on configured grant, a time domain resource corresponding to a TO in a CG period configured by the network device to the terminal device based on configured grant, a frequency domain resource corresponding to a TO in a CG period configured by the network device to the terminal device based on configured grant, or a time-frequency domain resource corresponding to a TO in a CG period configured by the network device to the terminal device based on configured grant.

In combination with some embodiments of the first aspect, in some embodiments, transmission of the first information is performed via a first channel. The first channel includes at least one of: a dynamic grant physical uplink shared channel (DG PUSCH); a configured grant physical uplink shared channel (CG PUSCH); or a physical uplink control channel (PUCCH).

In combination with some embodiments of the first aspect, in some embodiments, before sending the first information to the network device, the method further includes: receiving first configuration information sent by the network device, in which the first configuration information is used to configure the first information to include the first indicator.

In the above embodiment, the network device sends the first configuration information to the terminal to configure the first information, thereby ensuring successful sending of the first information, thus achieving a successful indication of the usage case of the TO and ensuring that the network device can know the usage case of the TO by the terminal. Therefore, the network device can schedule an unused TO of the terminal to be reused for uplink transmitting of other terminals, avoiding idleness of resources and ensuring an efficiency of uplink transmitting.

In combination with some embodiments of the first aspect, in some embodiments, the first information includes a first indication field, and the first indication field is used to indicate that the first information includes the first indicator.

In combination with some embodiments of the first aspect, in some embodiments, the method further includes: receiving second configuration information sent by the network device, in which the second configuration information is used to configure the first information to include the first indication field.

In the above embodiment, with configuring the first information to include the first indication field, and configuring the first indication field to indicate that the first information includes the first indicator. Thus, the terminal and the network device can determine whether the first information includes the first indicator based on the first indication field. Then, when reusing an original field in the first information to send the first indicator, the terminal and the network device can achieve a unified understanding of the content carried by the first information based on the first indication field in the first information, thus, the solution of “reusing the original field in the first information to carry and send the first indicator” can be successfully implemented, without the need to design new signaling or add a new field in the first information to carry the first indicator, which reduces workloads and reduces resource costs.

In combination with some embodiments of the first aspect, in some embodiments, the first information is sent on a TO of a first CG period, and the first CG period is a CG period used for transmission of relevant data of a predetermined service.

In the above embodiment, when the first information is sent on the TO of the first CG period, it means that the first information includes the first indicator. Therefore, the terminal and the network device can know whether the first information includes the first indicator by determining whether a CG period for sending the first information is the first CG period. Then, when reusing an original field in the first information to send the first indicator, the terminal and the network device can achieve a unified understanding of the content carried by the first information based on the CG period for sending the first information, thus, the solution of “reusing the original field in the first information to carry and send the first indicator” can be successfully implemented, without the need to design new signaling or add a new field in the first information to carry the first indicator, which reduces workloads and reduces resource costs.

In combination with some embodiments of the first aspect, in some embodiments, the first information is sent on a first TO, and the first TO is a TO used for transmission of relevant data of a predetermined service.

In the above embodiment, when the first information is sent on the first TO, it means that the first information includes the first indicator. Therefore, the terminal and the network device can know whether the first information includes the first indicator by determining whether a TO for sending the first information is the first TO. Then, when reusing an original field in the first information to send the first indicator, the terminal and the network device can achieve a unified understanding of the content carried by the first information based on the TO for sending the first information, thus, the solution of “reusing the original field in the first information to carry and send the first indicator” can be successfully implemented, without the need to design new signaling or add a new field in the first information to carry the first indicator, which reduces workloads and reduces resource costs.

In combination with some embodiments of the first aspect, in some embodiments, the first information is sent via a first transmission resource in a first channel, and the first transmission resource includes any one or more predefined transmission resources in the first channel.

In the above embodiment, when the first information is sent on the first transmission resource in the first channel, it means that the first information includes the first indicator. Therefore, the terminal and the network device can know whether the first information includes the first indicator by determining whether a transmission resource for sending the first information is the first transmission resource in the first channel. Then, when reusing the original field in the first information to send the first indicator, the terminal and the network device can achieve a unified understanding of the content carried by the first information based on the transmission resource for sending the first information, thus, the solution of “reusing the original field in the first information to carry and send the first indicator” can be successfully implemented, without the need to design new signaling or add a new field in the first information to carry the first indicator, which reduces workloads and reduces resource costs.

In combination with some embodiments of the first aspect, in some embodiments, the first information is scrambled using a first radio network temporary identifier (RNTI), and the first RNTI is a predefined RNTI used to scramble the first information including the first indicator.

In the above embodiment, when the first information is encrypted by the first RNTI, it means that the first information includes the first indicator. Therefore, the terminal and the network device can know whether the first information includes the first indicator by determining whether a RNTI used to scramble the first information is the first RNTI. When reusing the original field in the first information to send the first indicator, the terminal and the network device can achieve a unified understanding of the content carried by the first information based on the RNTI used to scramble the first information, thus, the solution of “reusing the original field in the first information to carry and send the first indicator” can be successfully implemented, without the need to design new signaling or add a new field in the first information to carry the first indicator, which reduces workloads and reduces resource costs.

In combination with some embodiments of the first aspect, in some embodiments, the method further includes: determining a priority of a first channel and a priority of a second channel, in which the second channel is a channel without carrying the first information, and the first channel conflicts with at least one second channel; sending the first information to the network device based on the priority of the first channel and/or the priority of the second channel.

In combination with some embodiments of the first aspect, in some embodiments, the second channel includes at least one of: a DG PUSCH; a CG PUSCH; or a PUCCH.

In conjunction with some embodiments of the first aspect, in some embodiments, the first channel conflicting with the second channel includes at least one of:
a transmission resource of the first channel at least partially overlapping with a transmission resource of the second channel; or
a transmission resource carrying the first information in the first channel at least partially overlapping with a transmission resource of the second channel.

In combination with some embodiments of the first aspect, in some embodiments, the priority of the first channel is determined based on a predefined protocol; or
the priority of the first channel is configured by the network device to the terminal; or
the priority of the first channel is determined by the terminal.

In combination with some embodiments of the first aspect, in some embodiments, sending the first information to the network device based on the priority of the first channel and/or the priority of the second channel includes at least one of:
discarding the second channel in a case where the priority of the first channel is higher than the priority of the second channel; or
discarding the first channel in a case where the priority of the first channel is lower than the priority of the second channel;
discarding the second channel in a case where the priority of the first channel is equal to the priority of the second channel;
multiplexing the second channel into the first channel in a case where the priority of the first channel is equal to the priority of the second channel;
discarding the first channel in a case where the priority of the first channel is equal to the priority of the second channel;
discarding the second channel in a case where the priority of the first channel is equal to the priority of the second channel and a transmission resource in the first channel that conflicts with the second channel includes a transmission resource carrying the first information;
discarding a transmission resource in the first channel that conflicts with the second channel in a case where the priority of the first channel is equal to the priority of the second channel and a transmission resource in the first channel that conflicts with the second channel includes a transmission resource without carrying the first information;
discarding the second channel in a case where the priority of the first channel is a first priority;
discarding the second channel in a case where the priority of the first channel is the first priority, and a transmission resource in the first channel that conflicts with the second channel includes a transmission resource carrying the first information;
discarding the first channel in a case where the priority of the first channel is a second priority;
discarding the first channel in a case where the priority of the first channel is the second priority and a transmission resource in the first channel that conflicts with the second channel includes a transmission resource carrying the first information.

In combination with some embodiments of the first aspect, in some embodiments, the first priority is higher than the second priority.

In the above embodiment, the priority of the first channel carrying the first information is defined. Then, when a channel conflict occurs between the first channel and other channels, the first channel or other channels may be selected to be sent based on the priority of the first channel and/or the priority of other channels, thereby proposing a conflict resolution method for resolving the channel conflict between the first channel carrying the first indicator and other channels, and ensuring a stability of channel transmission.

In combination with some embodiments of the first aspect, in some embodiments, the first information includes CG uplink control information (UCI).

In a second aspect, an embodiment of the present disclosure provides an information transmission method. The method includes: receiving first information sent by a terminal, in which the first information includes a first indicator, and the first indicator is used to indicate one or more usage cases of one or more transmission occasions (TOs).

In the above embodiment, the terminal may send the first information to the network device, to indicate the usage case of the TO by the terminal to the network device, thereby achieving a successful indication of the usage case of the TO and ensuring that the network device can know the usage case of the TO by the terminal. Therefore, the network device can schedule an unused TO of the terminal to be reused for uplink transmitting of other terminals, avoiding idleness of resources and ensuring an efficiency of uplink transmitting.

In combination with some embodiments of the first aspect, in some embodiments, transmission of the first information is performed via a first channel.

The first channel includes at least one of: a DG PUSCH; a CG PUSCH; or a PUCCH.

In combination with some embodiments of the first aspect, in some embodiments, before receiving the first information sent by the terminal, the method further includes:
sending first configuration information to the terminal, in which the first configuration information is used to configure the first information to include the first indicator.

In combination with some embodiments of the second aspect, in some embodiments, the first information includes a first indication field, and the first indication field is used to indicate that the first information includes the first indicator.

In combination with some embodiments of the second aspect, in some embodiments, the method further includes:
sending second configuration information to the terminal, in which the second configuration information is used to configure the first information to include the first indication field.

In combination with some embodiments of the second aspect, in some embodiments, the first information is sent on a TO of a first CG period, and the first CG period is a CG period used for transmission of relevant data of a predetermined service.

In combination with some embodiments of the second aspect, in some embodiments, the first information is sent on a first TO, and the first TO is a TO used for transmission of relevant data of a predetermined service.

In combination with some embodiments of the second aspect, in some embodiments, the predetermined service is an extended reality (XR) service.

In combination with some embodiments of the second aspect, in some embodiments, the first information is sent via a first transmission resource in a first channel, and the first transmission resource includes any one or more predefined transmission resources in the first channel.

In combination with some embodiments of the second aspect, in some embodiments, the first information is scrambled using a first radio network temporary identifier (RNTI), and the first RNTI is a predefined RNTI used to scramble the first information including the first indicator.

In combination with some embodiments of the second aspect, in some embodiments, the method further includes: determining that the first information includes the first indicator.

In combination with some embodiments of the second aspect, in some embodiments, determining that the first information includes the first indicator includes: determining that the first information includes the first indicator based on at least one of first configuration information, second configuration information, a CG period for sending the first information, a TO for sending the first information, a transmission resource for sending the first information, and a RNTI for scrambling the first information.

In combination with some embodiments of the second aspect, in some embodiments, determining, based on the second configuration information, that the first information includes the first indicator includes: determining that the first information includes the first indicator based on a value carried in a first indication field of the first information.

In combination with some embodiments of the second aspect, in some embodiments, after receiving the first information, the method further includes: processing the first information in a first manner, in which the first manner is a processing manner corresponding to information including the first indicator.

In combination with some embodiments of the second aspect, in some embodiments, the method further includes: receiving second information, in which the second information does not include the first information; processing the second information in a second manner, in which the second manner is different from the first manner, and the second manner is a processing manner corresponding to information without including the first indicator.

In a third aspect, embodiments of the present disclosure provide a first information transmission apparatus. The first information transmission apparatus includes a transceiver module, configured to send first information to a network device, in which, the first information includes a first indicator, and the first indicator is used to indicate one or more usage cases of one or more transmission occasions (TOs).

In a fourth aspect, embodiments of the present disclosure provide a second information transmission apparatus. The second information transmission apparatus includes a transceiver module, configured to receive first information sent by a terminal, in which, the first information includes a first indicator, and the first indicator is used to indicate one or more usage cases of one or more transmission occasions (TOs).

In a fifth aspect, embodiments of the present disclosure provide a communication device. The communication device includes one or more processors. The processor is configured to call instructions to enable the communication device to perform the information transmission method as described in any one of the first aspect and the second aspect.

In a sixth aspect, embodiments of the present disclosure provide a communication system. The communication system includes a terminal and a network device. The terminal is configured to implement the method as described in the first aspect and an optional implementation of the first aspect, and the network device is configured to implement the method as described in the second aspect and an optional implementation of the second aspect.

In a seventh aspect, an embodiment of the present disclosure proposes a storage medium having instructions stored thereon. When the instructions are performed on a communication device, the communication device is caused to perform the information transmission method as described in any one of the first aspect and the second aspect.

In an eighth aspect, an embodiment of the present disclosure proposes a program product which, when performed by a communication device, causes the communication device to perform the method as described in the first aspect, the optional implementation of the first aspect, the second aspect, or the optional implementation of the second aspect.

In a ninth aspect, an embodiment of the present disclosure proposes a computer program which, when performed on a computer, causes the computer to perform the method as described in the first aspect, the optional implementation of the first aspect, the second aspect, or the optional implementation of the second aspect.

It is understandable that the first information transmission apparatus, the second information transmission apparatus, the communication device, the communication system, the storage medium, the program product, and the computer program are all configured to perform the method proposed in the embodiments of the present disclosure. Therefore, for beneficial effects that can be achieved by the first information transmission apparatus, the second information transmission apparatus, the communication device, the communication system, the storage medium, the program product, and the computer program, reference can be made to the beneficial effects of the corresponding method, and details are not repeated herein.

The present disclosure proposes an information transmission method, an information transmission apparatus, and a communication device, a communication system and a storage medium. In some embodiments, terms such as information transmission method, information processing method, and communication method, etc. can be replaced with each other, terms such as information transmission apparatus, information processing apparatus, communication apparatus, etc. can be replaced with each other, and terms such as information processing system, communication system, etc. can be replaced with each other.

The embodiments of the present disclosure are not exhaustive, but are only illustrative of some embodiments, and are not intended to be a specific limitation on the scope of protection of the present disclosure. In the absence of contradiction, each step in a certain embodiment can be implemented as an independent embodiment, and respective steps can be arbitrarily combined. For example, a solution after removing some steps in a certain embodiment can also be implemented as an independent embodiment, and an order of the steps in a certain embodiment can be arbitrarily exchanged. In addition, optional implementations in a certain embodiment can be arbitrarily combined. In addition, respective embodiments can be arbitrarily combined with other, for example, some or all steps of different embodiments can be arbitrarily combined, and a certain embodiment can be arbitrarily combined with the optional implementations of other embodiments.

In each embodiment of the present disclosure, unless otherwise specified or there is a logical conflict, the terms and/or descriptions between the embodiments are consistent and can be referenced to each other, and the technical features in different embodiments can be combined to form a new embodiment based on their internal logical relationships.

The terms used in the embodiments of the present disclosure are only for the purpose of describing specific embodiments and are not intended to limit the present disclosure.

In embodiments of the present disclosure, unless otherwise specified, elements expressed in the singular form, such as “a”, “an”, “the”, “above”, “said”, “aforementioned”, “this”, etc., may mean “one and only one”, or “one or more”, “at least one”, etc. For example, when using articles such as “a”, “an”, “the” in English translation, a noun after the article may be understood as a singular expression or a plural expression.

In embodiments of the present disclosure, “a plurality of” refers to two or more.

In some embodiments, the terms “at least one of”, “one or more”, “a plurality of”, “multiple”, etc. may be used interchangeably.

In embodiments of the present disclosure, descriptions such as “at least one of A, B, C . . . ”, “A and/or B and/or C . . . ”, etc. include a situation where any one of A, B, C . . . exists alone, and also include a situation where any combination of any multiple ones of A, B, C, and each situation can exist alone. For example, “at least one of A, B, C” includes a situation where A exists alone, a situation where B exists alone, a situation where C exists alone, a combination of A and B, a combination of A and C, a combination of B and C, and a combination of A, B and C. For example, A and/or B includes a situation where A exists alone, a situation where B exists alone, and a combination of A and B.

In some embodiments, the descriptions such as “in one case, A; in another case, B”, “in response to one case, A; in response to another case, B”, etc. may include the following technical solutions according to situations: A is executed independently of B, that is, in some embodiments, A; B is executed independently of A, that is, in some embodiments, B; A and B are selectively executed, that is, in some embodiments, one is selected from A and B to be executed; both A and B are executed, that is, in some embodiments, A and B. When there are more branches such as A, B, C, etc., the above is applicable.

The prefixes such as “first” and “second” in the embodiments of the present disclosure are only used to distinguish different descriptive objects, and do not constitute restrictions on the position, order, priority, quantity or content of the descriptive objects. For the statement of the descriptive objects, reference may be made to the description in the context of the claims or embodiments, and it should not constitute redundant restrictions due to the use of prefixes. For example, if the descriptive object is “field”, the ordinal number before the “field” in the “first field” and the “second field” does not limit the position or order between the “fields”, and the terms “first” and “second” do not limit whether the “fields” they modify are in the same message, nor do they limit the order of the “first field” and the “second field”. For another example, if the descriptive object is “level”, the ordinal number before the “level” in the “first level” and the “second level” does not limit the priority between the “levels”. For another example, the number of descriptive objects is not limited by the ordinal number, and can be one or more. Taking the “first apparatus” as an example, the number of “apparatuses” can be one or more. In addition, the objects modified by different prefixes may be the same or different. For example, if the descriptive object is “apparatus”, the “first apparatus” and the “second apparatus” may be the same apparatus or different apparatuses, and their types may be the same or different. For another example, if the descriptive object is “information”, the “first information” and the “second information” may be the same information or different information, and their contents may be the same or different.

In some embodiments, “including A”, “comprising A”, “used to indicate A”, and “carrying A” can be interpreted as directly carrying A or indirectly indicating A.

In some embodiments, terms such as “in response to . . . ” , “in response to determining . . . ”, “in a case of . . . ” , “upon”, “when”, “if”, “in case of”, etc. can be used interchangeably.

In some embodiments, terms such as “greater than”, “greater than or equal to”, “not less than”, “more than”, “more than or equal to”, “not less than”, “higher than”, “higher than or equal to”, “not lower than”, and “above” can be replaced with each other, and terms such as “less than”, “less than or equal to”, “not greater than”, “less than”, “less than or equal to”, “no more than”, “lower than”, “lower than or equal to”, “not higher than”, and “below” can be replaced with each other.

In some embodiments, the apparatus, etc. can be interpreted as physical or virtual, and their names are not limited to the names mentioned in the embodiments, and terms such as “apparatus”, “equipment”, “device”, “circuit”, “network element”, “node”, “function”, “unit”, “section”, “system”, “network”, “chip”, “chip system”, “entity”, and “subject” and the like can be used interchangeably.

In some embodiments, terms “access network device (AN device)”, “radio access network device (RAN device)”, “base station (BS)”, “radio base station”, “fixed station”, “node”, “access point”, “transmission point (TP)”, “reception point (RP)”, “transmission/reception point (TRP)”, “panel”, “antenna panel”, “antenna array”, “cell”, “macro cell”, “small cell”, “femto cell”, “pico cell”, “sector”, “cell group”, “carrier”, “component carrier”, “bandwidth part (BWP)” and the like can be used interchangeably.

In some embodiments, terms “terminal”, “terminal device”, “user equipment (UE)”, “user terminal”, “mobile station (MS)”, “mobile terminal (MT)”, “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client” and the like may be used interchangeably.

In some embodiments, the access network device, the core network device, or the network device can be replaced by the terminal. For example, various embodiments of the present disclosure can also be applied to a structure in which communication between the access network device, the core network device, or the network device and the terminal is replaced by communication between multiple terminals (for example, also be referred to as device-to-device (D2D), vehicle-to-everything (V2X), etc.). In this case, the terminal can also be configured to have a structure that has all or part of the functions of the access network device. In addition, language such as “uplink” and “downlink” can also be replaced by the language corresponding to the communication between the terminals (for example, “side”). For example, an uplink channel, a downlink channel, etc. can be replaced by a side channel, and an uplink, a downlink, etc. can be replaced by a side link.

In some embodiments, the terminal may be replaced by the access network device, the core network device, or the network device. In this case, the access network device, the core network device, or the network device may also be configured to have a structure that has all or part of the functions of the terminal.

In some embodiments, a name of information, etc. is not limited to names mentioned in the embodiments, and terms such as “information”, “message”, “signal”, “signaling”, “report”, “configuration”, “indication”, “instruction”, “command”, “channel”, “parameter”, “domain”, “field”, “symbol”, “code element”, “codebook”, “codeword”, “codepoint”, “bit”, “data”, “program”, and “chip” and the like can be used interchangeably.

In some embodiments, terms such as “uplink”, “up link”, “physical uplink” can be interchangeable, and terms such as “downlink”, “down link”, “physical downlink” can be interchangeable, and terms such as “side”, “sidelink”, “side communication” , “sidelink communication”, “direct connection”, “direct link”, “direct communication”, “direct link communication” and the like can be interchangeable.

In some embodiments, terms “downlink control information (DCI)”, “downlink (DL) assignment”, “DL DCI”, “uplink (UL) grant”, “UL DCI” and the like may be used interchangeably.

In some embodiments, terms such as “physical downlink shared channel (PDSCH)”, “DL data” and the like can be interchangeable, and terms such as “physical uplink shared channel (PUSCH)”, “UL data” and the like can be interchangeable.

In some embodiments, terms such as “radio”, “wireless”, “radio access network (RAN)”, “access network (AN)”, “RAN-based” and the like may be used interchangeably.

In some embodiments, the terms “search space”, “search space set”, “search space configuration”, “search space set configuration”, “control resource set (CORESET)”, “CORESET configuration” and the like may be interchangeable.

In some embodiments, terms such as “synchronization signal (SS)”, “synchronization signal block (SSB)”, “reference signal (RS)”, “pilot”, “pilot signal” and the like can be used interchangeably.

In some embodiments, the terms such as “moment”, “time point”, “time”, “time position” and the like can be interchangeable, and the terms such as “duration”, “period”, “time window”, “window”, “time” and the like can be interchangeable.

In some embodiments, the terms “component carrier (CC)”, “cell”, “frequency carrier”, “carrier frequency” and the like may be used interchangeably.

In some embodiments, terms such as “resource block (RB)”, “physical resource block (PRB)”, “sub-carrier group (SCG)”, “resource element group (REG)”, “PRB pair”, “RB pair”, “resource element (RE)” and the like can be used interchangeably.

In some embodiments, the terms such as “wireless access scheme”, “waveform”, etc. may be used interchangeably.

In some embodiments, the terms such as “precoding”, “precoder”, “weight”, “precoding weight”, “quasi-co-location (QCL)”, “transmission configuration indication (TCI) state”, “spatial relation”, “spatial domain filter”, “transmission power”, “phase rotation”, “antenna port”, “antenna port group”, “layer”, “the number of layers”, “rank”, “resource”, “resource set”, “resource group”, “beam”, “beam width”, “beam angular degree”, “antenna”, “antenna element”, “panel” and the like can be used interchangeably.

In some embodiments, the terms such as “frame”, “radio frame”, “subframe”, “slot”, “sub-slot”, “mini-slot”, “symbol”, “symbol”, “transmission time interval (TTI)” and so on can be used interchangeably.

In some embodiments, “obtain”, “acquire”, “get”, “receive”, “transmit”, “bidirectional transmission”, “send and/or receive” can be interchangeable, and can be interpreted as receiving from other entities, obtaining from a protocol, obtaining by self-processing, autonomous implementation, etc.

In some embodiments, the terms such as “send”, “transmit”, “report”, “issue”, “transmit”, “bi-directionally transmit”, “send and/or receive” and the like can be used interchangeably.

In some embodiments, “predetermined” or “preset” may be interpreted as being pre-specified in a protocol, etc., or may be interpreted as an apparatus performing a pre-set action, etc.

In some embodiments, “determining” can be interpreted as “judging”, “deciding”, “judging”, “calculating”, “computing”, “processing”, “deriving”, “investigating”, “searching”, “looking up”, “searching”, “inquiring”, “ascertaining”, “receiving”, “transmitting”, “inputting”, “outputting, “accessing”, “resolving”, “selecting”, “choosing”, “establishing”, “comparing”, “assuming”, “expecting”, “considering”, “broadcasting”, “notifying”, “communicating”, “forwarding”, “configuring”, “reconfiguring”, “allocating”, “mapping”, “assigning”, etc., but is not limited to the above.

In some embodiments, the determination or judgment may be performed by a value represented by 1 bit (0 or 1), or by a true/false value (Boolean value) represented by true or false, or by comparison of numerical values (for example, comparison with a predetermined value), but is not limited thereto.

In some embodiments, “network” may be interpreted as apparatuses included in the network (e.g., access network device, core network device, etc.).

In some embodiments, “not expecting to receive” can be interpreted as not receiving on time domain resources and/or frequency domain resources, or as not performing subsequent processing on the data after receiving the data; “not expecting to send” can be interpreted as not sending, or as sending but not expecting the recipient to respond to the sent content.

In some embodiments, acquisition of data, information, etc. may comply with the laws and regulations of the country where the data is obtained.

In some embodiments, data, information, etc. may be obtained with the user's consent.

In addition, each element, each row, or each column in the table of the embodiments of the present disclosure may be implemented as an independent embodiment, and the combination of any elements, any rows, or any columns may also be implemented as an independent embodiment.

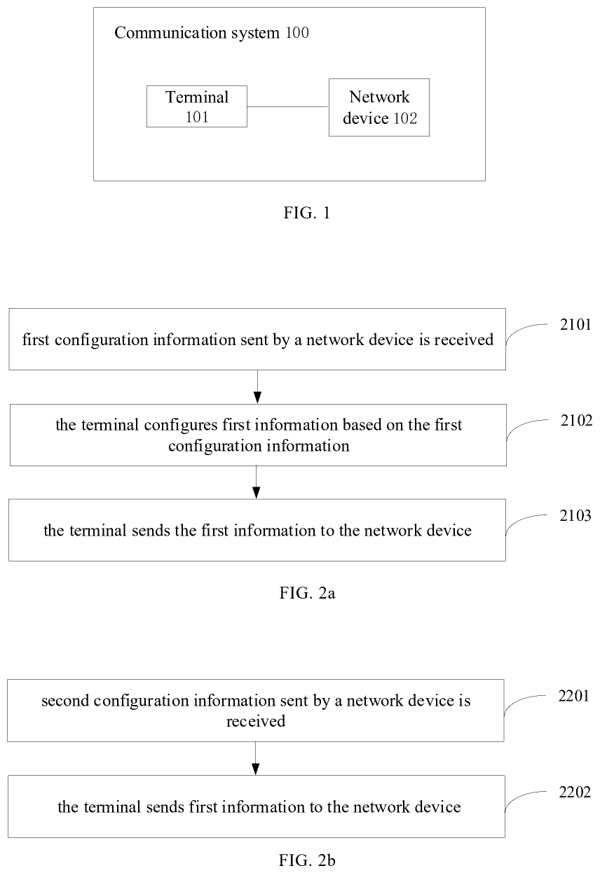

FIG. 1 is a schematic diagram of a communication system according to an embodiment of the present disclosure. As shown in FIG. 1, the communication system 100 may include a terminal 101 and a network device 102. The network device 102 may include an access network device.

In some embodiments, the terminal 101, for example, may include at least one of a mobile phone, a wearable device, an Internet of Things device, a car with a communication function, a smart car, a Pad, a computer with a wireless receiving and sending function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, or a wireless terminal in smart home, but is not limited thereto.

In some embodiments, the access network device may be, for example, a node or device that accesses a terminal to a wireless network. The access network device may include at least one of an evolved NodeB (eNB), a next generation eNB (ng-eNB), a next generation NodeB (gNB), a node B (NB), a home node B (HNB), a home evolved nodeB (HeNB), a wireless backhaul device, a radio network controller (RNC), a base station controller (BSC), a base transceiver station (BTS), a base band unit (BBU), a mobile switching center, a base station in a 6G communication system, an open base station (Open RAN), a cloud base station (Cloud RAN), a base station in other communication systems, or an access node in a wireless fidelity (WiFi) system, but is not limited thereto.

In some embodiments, the technical solution of the present disclosure may be applicable to an Open RAN architecture. In this case, the interfaces between or within the access network devices involved in the embodiments of the present disclosure may become internal interfaces of the Open RAN, and the processes and information interactions between these internal interfaces may be implemented through software or programs.

In some embodiments, the access network device may include a central unit (CU) and a distributed unit (DU), in which the CU may also be called a control unit. A protocol layer of the access network device may be divided by adopting the CU-DU structure. Some functions of the protocol layer are centrally controlled by the CU, and some or all of remaining functions of the protocol layer are distributed in the DU which is centrally controlled by the CU, but is not limited thereto.

It can be understood that the communication system described in the embodiments of the present disclosure aims to more clearly illustrate the technical solution of the embodiments of the present disclosure, and does not constitute a limitation on the technical solution proposed in the embodiments of the present disclosure. A person skilled in the art can know that with the evolution of the system architecture and the emergence of new business scenarios, the technical solution proposed in the embodiments of the present disclosure are also applicable to similar technical problems.

The following embodiments of the present disclosure may be applied to the communication system 100 or part of the subjects shown in FIG. 1, but are not limited thereto. The subjects shown in FIG. 1 are examples, and the communication system may include all or part of the subjects in FIG. 1, or may include other subjects other than those shown in FIG. 1, and the number and form of the subjects are arbitrary, and the connection relationships between the subjects are examples, and the subjects may be connected or disconnected, and the connection may be in any manner, which may be a direct connection or an indirect connection, and may be a wired connection or a wireless connection.

The embodiments of the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), future radio access (FRA), new radio access technology (RAT), new radio (NR), new radio access (NX), future generation radio access (FX), Global System for Mobile communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), Public Land Mobile Network (PLMN) network, Device-to-Device (D2D) system, Machine-to-Machine (M2M) system, Internet of Things (IoT) system, Vehicle-to-Everything (V2X), systems using other communication methods, and next-generation systems based on them. In addition, multiple systems can also be combined (for example, a combination of LTE or LTE-A and 5G, etc.) for application.

In an example, the network device configures at least one set of CG periods for the terminal. For example, the network device may configure at least one set of CG periods for the terminal on a bandwidth part (BWP), and the CG period supports up to 14*40960 symbols, and the CG period may include one or more TOs. For example, the method for the above-mentioned network device to configure at least one set of CG periods for the terminal may be implemented as follows. The network device may configure at least one set of CG periods for the terminal through a higher-layer signaling (such as Radio Resource Control (RRC) signaling), or the network device may configure partial information of at least one set of CG periods for the terminal through a high-layer signaling (such as RRC signaling) and send a dynamic signaling (such as downlink control information (DCI) signaling) to the terminal. The dynamic signaling may include remaining information of the at least one CG period for activating the CG period. Alternatively, up to 12 sets of CG periods may be configured and activated on one BWP, and each set of CG periods is identified by an index.

In an example, when the network device successfully configures at least one set of CG periods for the terminal, and the CG period includes multiple TOs, the terminal may select the TO to be used by the terminal from all TOs in the CG period. Alternatively, the terminal may select at least part of the TOs in the CG period as “used TOs”, and the remaining TOs (that is, TOs other than “TOs selected to be used by the terminal” in at least one CG period configured by the network device) are considered to be “unused TOs” of the terminal. Alternatively, for the “used TO” selected by the terminal, the terminal may selectively actually use the TO, for example, using the TO for uplink transmission, or may not use the TO, for example, not using the TO for uplink transmission. For the “unused TO” selected by the terminal, the terminal will not use the TO, for example, not using the TO for uplink transmission.

In an example, after the terminal selects the TO to be used by the terminal from all TOs in the CG period, the terminal may send a first indication to the network device to indicate the usage case of the TO in the CG period, so that the network device may determine the “unused TO” in the CG period based on the first indication. The network device may then schedule the TO not used by the terminal to be reused for uplink transmissions of other terminals, thereby avoiding idleness of resources, and improving an efficiency of uplink transmissions.

In an example, a terminal generally sends a first indicator to a network device via uplink control information (UCI). For example, a method of sending the first indicator to the network device via the UCI may include at least one of the following methods.

A first method is to design a new UCI, which is different from an existing UCI. For example, the existing UCI may be a CG UCI. The content carried in the CG UCI is one or more of a hybrid automatic repeat request (HARQ) process number, a redundancy version, a new data indicator, or channel occupancy time (COT) sharing information. The new UCI is different from the existing CG UCI, and the new UCI is used to carry the above first indicator. The terminal sends the above first indicator to the network device by sending the new UCI to the network device.

A second method is to add a new field to the existing UCI (i.e., CG UCI), and the new field is used to carry the above first indicator.

A third method is to reuse an original field in the existing UCI (i.e., CG UCI) to carry the above first indicator.

Regarding the third method mentioned above, how the network device and the terminal have a unified understanding of information in the CG UCI (that is, how the network device and the terminal determine at which time points the CG UCI sent is a UCI that “reuses the original field to carry the first indicator”, and at which time points the CG UCI sent is a UCI that “does not reuse the original field to carry the first indicator”) is an urgent technical problem that is to be solved.

In addition, during uplink transmitting (such as sending the CG UCI) of the terminal, a channel conflict may occur. In this case, it is required to select discarding or multiplexing a channel based on a priority of the channel. In an example, in a case where it is originally required to use the CG UC to carry the first indicator, the loss of the CG UCI only affects a TO for a current transmission, but if the CG UCI carries the first indicator, the loss of the CG UCI may affect scheduling of reusing “unused TO”. In an example, a priority of scheduling of reusing “unused TO” may be a high priority. Therefore, for a scenario of “channel conflict occurs in a UCI carrying the first indicator”, a conflict resolution method is to be proposed.

In an example, in some embodiments, the method of the present disclosure may be applied to a first service scenario, which may be a service scenario with low latency and high throughput requirements. For example, in some embodiments, the method of the present disclosure may be applied to an extended reality (XR) service scenario, where XR is a general term for virtual reality (VR), augmented reality (AR), and mixed reality (MR).

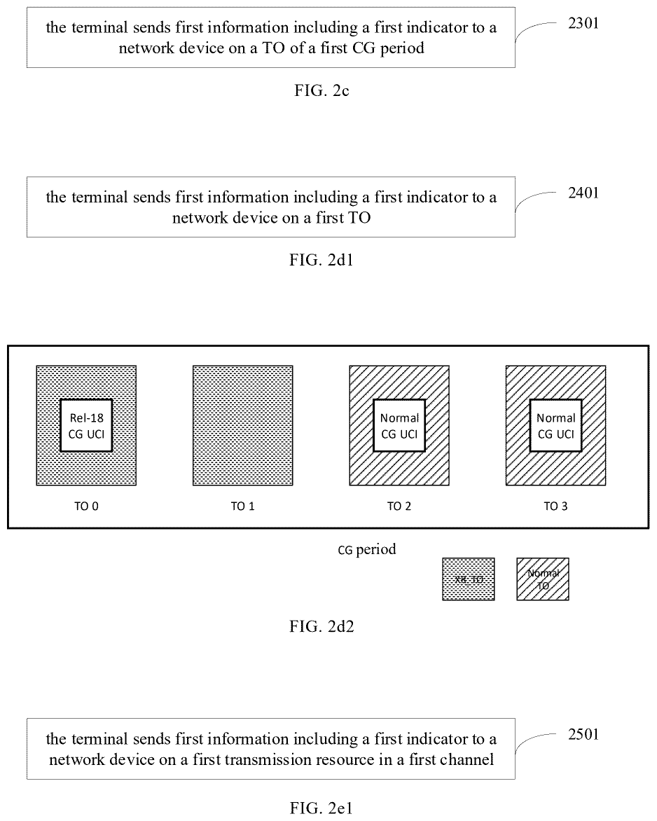

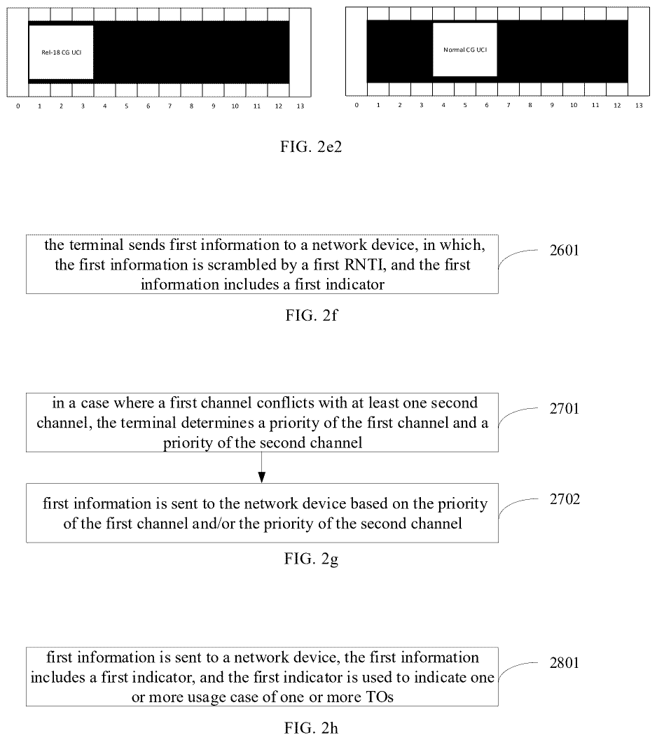

FIG. 2a is an interactive schematic diagram of an information transmission method provided by an embodiment of the present disclosure. As shown in FIG. 2a, an embodiment of the present disclosure relates to an information transmission method. The method is performed by a terminal 101, and includes the following steps.

At step 2101, first configuration information sent by a network device is received.

In some embodiments, the first configuration information may be used to configure first information.

In some embodiments, the first information may be sent by the terminal to the network device, and the first information may include a first indicator, and the first indicator may be used to indicate one or more usage cases of one or more TOs. In an example, the terminal sends the first indicator to the network device, such that the network device may determine the usage case of the terminal for the TO based on the first indicator, and then determine an unused TO of the terminal. The network device may schedule the unused TO to be reused for uplink transmitting of other terminals, thereby avoiding idleness of resources and ensuring a transmission efficiency. When the network device knows which TO is the unused TO of the terminal and the unused TO have not been scheduled for reuse, it may no longer monitor the TO, thereby saving a resource overhead.

In some embodiments, the first information may also not include the first indicator. In an example, the first information may be a UCI, for example, a CG UCI. In an example, transmission of the first information is performed via a first channel. The first channel includes at least one of the following: a dynamic grant physical uplink shared channel (DG PUSCH); a configured grant physical uplink shared channel (CG PUSCH); a physical uplink control channel (PUCCH).

It can be seen from the above content that the first information may include or not include the first indicator. Based on this, in some embodiments, since the different contents are included in the first information in different situations, the network device decodes the first information in different situations in different manners. The different contents are included in the first information in different situations, and the first information has different formats in different situations. Therefore, the terminal and the network device need to have a unified understanding for the first information sent, such that after the terminal sends the first information to the network device, the network device may determine whether the first information includes the first indicator, and in a case where the first information includes the first indicator, the network device may obtain the first indicator from the first information.

Based on this, in some embodiments, the network device may send first configuration information to the terminal, and the first configuration information may be configured for the terminal with the first information being configured or without being configured with (or referred to as including or without including) the first indicator. In an example, in a case where the first information is configured to include the first indicator, the terminal and the network device process an information field of the first information in a first manner (or referred to as: process the information field of the first information in accordance with an information field processing mechanism in Rel-18) to obtain the first indicator from the first information. In a case where the first information is configured not to include the first indicator, the terminal and the network device process the information field of the first information in a second manner (or referred to as: process the information field of the first information in accordance with an information field processing mechanism in Rel-15\16\17), thereby realizing unified understanding of the terminal and the network device for the first information.

In an example, the first manner described above is different from the second manner. In an example, the first manner described above may be a processing manner corresponding to information including the first indicator; and the second manner described above may be a processing manner corresponding to information without including the first indicator. In an example, in a case where the first information does not include the first indicator, it is considered that the first information is not reused to carry the first indicator. In this case, the content included in the first information may be one or more of a HARQ process number, a redundancy version, a new data indicator, or COT sharing information. In a case where the first information includes the first indicator, it is considered that the first information is reused to carry the first indicator. In this case, in addition to the first indicator, the first information may also include other content. The other content may include one or more of the HARQ process number, the redundancy version, the new data indicator, or the COT sharing information, or may not be the HARQ process number, the redundancy version, the new data indicator, or the COT sharing information.

In an example, it should be noted that, in some embodiments, when the network device configures the first information through the first configuration information, a specific principle of how to decide whether to configure the first information to include the first indicator or not to include the first indicator may be that: when the network device discovers a relative short of a current transmission resource, for example, in a case where the number of currently available transmission resources of the network device is less than a first threshold, the network device may configure for the terminal that the first information includes the first indication through the first configuration information, so that the terminal may send the first indicator to the network device through the first information. Then, the network device may know the unused TO of the terminal based on the first indicator. In this case, the network device may schedule and reuse the unused TO of the terminal to solve the problem of “relatively short of transmission resources”. Similarly, when the network device finds that the current transmission resources are relatively abundant, it does not need to schedule the unused TO of the terminal for other transmissions. Therefore, the network device may configure for the terminal that the first information does not include the first indicator through the first configuration information.

In some embodiments, the first configuration information may be sent by the network device to the terminal via high-layer signaling (such as RRC signaling).

At step 2102, the terminal configures first information based on the first configuration information.

In some embodiments, the method of the terminal configuring the first information based on the first configuration information may include that: in a case where the first configuration information configures the first information without including the first indicator, the first indicator is not configured in the first information. In this case, the first information does not include the first indicator.

In some embodiments, the method of the terminal configuring the first information based on the first configuration information may include that: in a case where the first configuration information configures the first information to include the first indicator, the first indicator is configured in the first information. In this case, the first information includes the first indicator.

It can be seen from the above steps 2101-2102 that when the original field in the first information is reused to carry the first indicator, the network device and the terminal can determine whether the first information includes the first indicator based on the above first configuration information, so that the terminal and the network device can achieve a unified understanding of the content carried by the first information based on the first configuration information. Thus, the solution of “reusing the original field in the first information to carry and send the first indicator” can be successfully implemented, without the need to design new signaling or add a new field in the first information to carry the first indicator, which reduces workloads and reduces resource costs.

At step 2103, the terminal sends the first information to the network device.

The information transmission method involved in embodiments of the present disclosure may include at least one of steps S2101 to S2103. For example, step S2101 may be implemented as an independent embodiment, step S2102 may be implemented as an independent embodiment, and steps S2101 and S2102 may be implemented as an independent embodiment, which are not limited herein.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 2b is an interactive schematic diagram of an information transmission method provided by an embodiment of the present disclosure. As shown in FIG. 2b, an embodiment of the present disclosure relates to an information transmission method. The method is performed by a terminal 101, and includes the following steps.

At step 2201, second configuration information sent by a network device is received.

In some embodiments, the second configuration information may be used to configure the first information. In an example, the second configuration information may be used to configure the first information to include a first indication field. For a detailed introduction to the first information, reference may be made to the aforementioned embodiment. In an example, the first indication field indicates whether the first information including the first indication field includes the first indicator by carrying different values. In an example, a bit width of the first indication field may be, for example, 1 bit.

At step 2202, the terminal sends first information to the network device.

In some embodiments, the first information includes a first indication field. In an example, in a case where the value carried in the first indication field is a first value (such as 1), it indicates that the first information includes the first indicator. In this case, the terminal and the network device process an information field of the first information in a first manner (or referred to as: process the information field of the first information in accordance with an information field processing mechanism in Rel-18). In a case where the value carried in the first indication field is a second value (such as 0), it indicates that the first information does not include the first indicator. In this case, the terminal and the network device process the information field of the first information in a second manner (or referred to as: process the information field of the first information in accordance with an information field processing mechanism in Rel-15\16\17)). For the relevant introduction of the first manner and the second manner, reference can be made to the aforementioned embodiment.

It should be noted that the first information including the first indication field may be configured by the second configuration information, or the terminal itself may determine that the first information includes the first indication field. In an example, in a case where the terminal determines that the first information includes the first indication field, step 2201 may not be performed, and step 2202 may be performed directly.

It should also be noted that, in some embodiments, in a case where the network device does not configure for the terminal with the first information including the first indication field, the terminal may also default that the first information does not include the first indication field.

It can be seen from the above steps 2201-2202 that, in a case where the original field in the first information is reused to carry the first indicator, the network device and the terminal can determine whether the first information includes the first indicator based on the value carried by the first indication field in the above first information, so that the terminal and the network device can achieve a unified understanding of the content carried by the first information based on the value carried by the first indication field. Thus, the solution of “reusing the original field in the first information to carry and send the first indicator” can be successfully implemented, without the need to design new signaling or add a new field in the first information to carry the first indicator, which reduces workloads and reduces resource costs.

The information transmission method involved in the embodiment of the present disclosure may include at least one of step S2201 to step S2202. For example, step S2201 may be implemented as an independent embodiment, and step S2202 may be implemented as an independent embodiment.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 2c is an interactive schematic diagram of an information transmission method provided by an embodiment of the present disclosure. As shown in FIG. 2c, an embodiment of the present disclosure relates to an information transmission method. The method is performed by a terminal 101, and includes the following steps.

At step 2301, the terminal sends first information including a first indicator to a network device on a TO of a first CG period.

For a detailed introduction to the first information, reference can be made to the aforementioned embodiment.

In some embodiments, the first CG period is a CG period used for transmission of relevant data of a predetermined service. In an example, the predetermined service may be an XR service. In an example, when the predetermined service is the XR service, the first CG period may be an XR_CG period.

It should be noted that, in some embodiments, in a case where the network device configures the CG period for the terminal, it indicates to the terminal which CG period in the configured CG periods is the XR_CG period, such that the terminal may determine which CG period is XR_CG period based on the indication of the network device. Afterwards, the terminal may send the first information including the first indicator to the network device on the TO of the XR_CG period.

It can be seen from the above content that when the first information is sent on TO in the first CG period (such as the XR_CG period), it means that the first information includes the first indicator.

In addition, it should be noted that the terminal can also send the first information without including the first indicator to the network device on a TO in a period other than the first CG period. That is, in a case where the first information is sent on the TO in the period other than the first CG period, it means that the first information does not include the first indicator.

In an example, the above “period other than the first CG period” can be understood as, for example, a CG period that is not used for transmission of the relevant data of the predetermined service (such as the XR service). For example, the above “period other than the first CG period” can be a CG period other than the XR_CG period.

It can be seen from the above step 2301 that in a case where the original field in the first information is reused to carry the first indicator, the network device and the terminal can determine whether the first information includes the first indicator based on whether the CG period for sending the first information is the first CG period, such that the terminal and the network device can achieve a unified understanding of the content carried by the first information based on the CG period for sending the first information. Thus, the solution of “reusing the original field in the first information to carry and send the first indicator” can be successfully implemented, without the need to design new signaling or add a new field in the first information to carry the first indicator, which reduces workloads and reduces resource costs.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 2d1 is an interactive schematic diagram of an information transmission method provided by an embodiment of the present disclosure. As shown in FIG. 2d1, an embodiment of the present disclosure relates to an information transmission method. The method is performed by a terminal 101, and includes the following steps.

At step 2401, the terminal sends first information including a first indicator to a network device on a first TO.

For a detailed introduction to the first information, reference can be made to the aforementioned embodiment.

In some embodiments, the first TO may be a TO used for transmission of relevant data of a predetermined service. In an example, the predetermined service may be an XR service. In an example, in a case where the predetermined service is the XR service, the first TO may be an XR_TO.

For the related introduction of the relevant service, reference can be made to the above embodiment of FIG. 2c.

It should be noted that, in some embodiments, in a case where the network device configures the CG period for the terminal, it may indicate to the terminal which TO in the configured CG periods is the XR_TO, so that the terminal may determine which TO is the XR_TO based on the indication of the network device. Afterwards, the terminal may send the first information including the first indicator to the network device on the XR_TO.

It can be known from the above content that in a case where the first information is sent on the first TO (such as XR_TO), it means that the first information includes the first indicator.

In addition, it should be noted that the terminal may also send the first information without including the first indicator to the network device on a TO other than the first TO. That is, in a case where the first information is sent on the TO other than the first TO, it indicates that the first information does not include the first indicator.

In an example, the above “TO other than the first TO” can be understood as, for example, a TO that is not used for transmission of the relevant data of the predetermined service (such as the XR service). For example, the above “TO other than the first TO” may be a TO other than the XR_TO.

It can be seen from the above step 2401 that in a case where the original field in the first information is reused to carry the first indicator, the network device and the terminal can determine whether the first information includes the first indicator based on whether the TO for sending the first information is the first TO, such that the terminal and the network device can achieve a unified understanding of the content carried by the first information based on the TO for sending the first information. Thus, the solution of “reusing the original field in the first information to carry and send the first indicator” can be successfully implemented, without the need to design new signaling or add a new field in the first information to carry the first indicator, which reduces workloads and reduces resource costs.

FIG. 2d2 is a schematic diagram of sending first information provided by an embodiment of the present disclosure. As shown in FIG. 2d2, TO0 and TO1 are XR_TOs (i.e., first TOs), TO2 and TO3 are TOs other than the XR_Tos. The first information including the first indicator (i.e., the Rel-18CG UCI in FIG. 2d2) is sent through TO0 and TO1, and the first information without including the first indicator (i.e., Normal CG UCI in FIG. 2d2) is sent through TO2 and TO3.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 2e1 is an interactive schematic diagram of an information transmission method provided by an embodiment of the present disclosure. As shown in FIG. 2e1, an embodiment of the present disclosure relates to an information transmission method. The method is performed by a terminal 101, and includes the following steps.

At step 2501, the terminal sends first information including a first indicator to a network device on a first transmission resource in a first channel.

For a detailed introduction to the first information, reference can be made to the aforementioned embodiment.

In some embodiments, the first transmission resource may include any one or more predefined transmission resources in the first channel. In an example, the transmission resource may be at least one of a time domain resource and a frequency domain resource. For example, the first transmission resource may be, for example, first three time domain resources (such as time domain symbols) in the first channel.

It can be known from the above content that when the first information is sent on the first transmission resource in the first channel, it means that the first information includes the first indicator.

In addition, it should be noted that the terminal may also send the first information without including the first indicator to the network device on a transmission resource other than the first transmission resource in the first channel. That is, in a case where the first information is sent on the transmission resource other than the first transmission resource in the first channel, it indicates that the first information does not include the first indicator.

For example, in a case where the first transmission resource is the first three time domain symbols in the first channel, the above “transmission resource other than the first transmission resource in the first channel” may be: time domain symbols in the first channel other than the first three time domain symbols. For example, the terminal may send the first information without including the first indicator on the fourth time domain symbol of the first channel.

It can be seen from the above step 2501 that in a case where the original field in the first information is reused to carry the first indicator, the network device and the terminal can determine whether the first information includes the first indicator based on whether the transmission resource for sending the first information is the first transmission resource, such that the terminal and the network device can achieve a unified understanding of the content carried by the first information based on the transmission resource for sending the first information. Thus, the solution of “reusing the original field in the first information to carry and send the first indicator” can be successfully implemented, without the need to design new signaling or add a new field in the first information to carry the first indicator, which reduces workloads and reduces resource costs.

For example, FIG. 2e2 is a schematic diagram of sending first information according to an embodiment of the present disclosure. Assumed that the first transmission resource includes first three time domain symbols used for transmission, as shown in FIG. 2e2, the first channel includes 14 time domain symbols, which are numbered 0-13 respectively, of which those numbered 1-3 are the first three time domain symbols used for transmission. Transmission of the first information including the first indicator (i.e., Rel-18CG UCI in FIG. 2e2) can be performed through the time domain symbols numbered 1-3 in the first channel shown in FIG. 2e2, and transmission of the first information without including the first indicator (i.e., Normal CG UCI in FIG. 2e2) can be performed through the time domain symbols numbered 4-6 in the first channel shown in FIG. 2e2.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 2f is an interactive schematic diagram of an information transmission method provided by an embodiment of the present disclosure. As shown in FIG. 2f, an embodiment of the present disclosure relates to an information transmission method. The method is performed by a terminal 101, and includes the following steps.

At step 2601, the terminal sends first information to a network device. The first information is scrambled by a first radio network temporary identifier (RNTI), and the first information includes a first indicator.

For a detailed introduction to the first information, reference can be made to the aforementioned embodiment.

In some embodiments, the first RNTI may be used to scramble the first information including the first indicator, and a second RNTI may be used to scramble the first information without including the first indicator. In an example, the first RNTI is different from the second RNTI. In an example, the second RNTI may be a currently existing RNTI, for example, a cell-radio network temporary identifier (C-RNTI), a random access-radio network temporary identifier (RA-RNTI), a temporary-C-radio network temporary identifier (T-C-RNTI), a system information-radio network temporary identifier (SI-RNTI), a paging-radio network temporary identifier (P-RNTI), a semi-persistent scheduling-C-radio network temporary identifier (SPS-C-RNTI). The first RNTI may be a newly designed RNTI different from the second RNTI. Alternatively, the first RNTI may be a part of the existing RNTIs, and the second RNTI may be a RNTI other than the first RNTI in the existing RNTIs. In an example, the first RNTI specifically refers to which RNTI may be pre-configured by the network device, or may be pre-defined by a protocol, or may be determined by the terminal and then reported to the network device.

It can be seen from the above content that in a case where the first information is scrambled by the first RNTI, it indicates that the first information includes the first indicator. In a case where the first information is scrambled by the second RNTI, it indicates that the first information does not include the first indicator. After the network device receives the first information sent by the terminal, it can use multiple different RNTIs to descramble the first information. In a case where the network device successfully descrambles the first information using the first RNTI, it indicates that the first information includes the first indicator, and in a case where the network device successfully descrambles the first information using the second RNTI, it indicates that the first information does not include the first indicator.

It can be seen from the above step 2601 that in a case where the original field in the first information is reused to carry the first indicator, the network device and the terminal can determine whether the first information includes the first indicator based on whether the RNTI used to scramble the first information is the first RNTI, such that the terminal and the network device can achieve a unified understanding of the content carried by the first information based on the RNTI used to scramble the first information. Thus, the solution of “reusing the original field in the first information to carry and send the first indicator” can be successfully implemented, without the need to design new signaling or add a new field in the first information to carry the first indicator, which reduces workloads and reduces resource costs.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 2g is an interactive schematic diagram of an information transmission method provided by an embodiment of the present disclosure. As shown in FIG. 2g, an embodiment of the present disclosure relates to an information transmission method. The method is performed by a terminal 101, and includes the following steps.

At step 2701, in a case where a first channel conflicts with at least one second channel, the terminal determines a priority of the first channel and a priority of the second channel.

In some embodiments, the first channel may refer to a channel carrying a first indicator, for example, the first channel may be a channel for carrying first information including the first indicator. The second channel may refer to a channel without carrying the first indicator, for example, the second channel may be a channel for carrying the first information without including the first indicator.

In some embodiments, the second channel may include at least one of: a DG PUSCH; a CG PUSCH; or a PUCCH.

In some embodiments, the above “the first channel conflicting with the second channel” may include at least one of:
a transmission resource of the first channel at least partially overlapping with a transmission resource of the second channel; or
a transmission resource carrying the first information in the first channel at least partially overlapping with a transmission resource of the second channel.

In an example, the above “transmission resources at least partially overlap” may include: transmission resources in the time domain at least partially overlap, or transmission resources in the frequency domain at least partially overlap, or transmission resources in the time domain and the frequency domain at least partially overlap.

In an example, in some embodiments, the priority of the first channel may be predefined by the terminal based on a protocol, or the priority of the first channel may be configured by the network device to the terminal, for example, configured by the network device to the terminal through high-level signaling (such as RRC signaling), or the priority of the first channel may be determined by the terminal.

In an example, the priority of the first channel determined by the terminal may be: a first priority (such as a high priority) or a second priority (such as a low priority).

In an example, the priority of the second channel is preset.

At step 2702, first information is sent to the network device based on the priority of the first channel and/or the priority of the second channel.

In an example, the method of “sending the first information to the network device based on the priority of the first channel and/or the priority of the second channel” may include at least one of:
discarding the second channel (i.e., transmitting the first channel first) in a case where the priority of the first channel is higher than the priority of the second channel (for example, the priority of the first channel is the high priority, and the priority of the second channel is the low priority); or
discarding the first channel (i.e., transmitting the second channel first) in a case where the priority of the first channel is lower than the priority of the second channel (for example, the priority of the first channel is the low priority, and the priority of the second channel is the high priority);
discarding the second channel in a case where the priority of the first channel is equal to the priority of the second channel (for example, the priority of the first channel is the high priority, and the priority of the second channel is the high priority);
multiplexing the second channel into the first channel (i.e., transmitting the first channel and the second channel simultaneously) in a case where the priority of the first channel is equal to the priority of the second channel;
discarding the first channel in a case where the priority of the first channel is equal to the priority of the second channel;
discarding the second channel in a case where the priority of the first channel is equal to the priority of the second channel and a transmission resource in the first channel that conflicts with the second channel includes a transmission resource carrying the first information;
discarding a transmission resource in the first channel that conflicts with the second channel (that is, transmitting the content required to be transmitted in the second channel on the transmission resource in which the first channel conflicts with the second channel) in a case where the priority of the first channel is equal to the priority of the second channel and a transmission resource in the first channel that conflicts with the second channel includes a transmission resource without carrying the first information;
discarding the second channel in a case where the priority of the first channel is a first priority (for example, the priority of the first channel is the high priority);
discarding the second channel in a case where the priority of the first channel is the first priority, and a transmission resource in the first channel that conflicts with the second channel includes a transmission resource carrying the first information;
discarding the first channel in a case where the priority of the first channel is a second priority (for example, the priority of the first channel is the low priority); or
discarding the first channel in a case where the priority of the first channel is the second priority and a transmission resource in the first channel that conflicts with the second channel includes a transmission resource carrying the first information.

In an example, the first priority mentioned above is higher than the second priority.

It can be seen from the above steps 2701-2702 that the priority of the first channel carrying the first information is defined. Then, when a channel conflict occurs between the first channel and other channels, the first channel or the second channel may be selected to be sent based on the priority of the first channel and/or the priority of the second channel, thereby proposing a conflict resolution method for resolving the channel conflict between the first channel carrying the first indicator and other channels, and ensuring a stability of channel transmission.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 2h is an interactive schematic diagram of an information transmission method provided by an embodiment of the present disclosure. As shown in FIG. 2h, an embodiment of the present disclosure relates to an information transmission method. The method is performed by a terminal 101, and includes the following steps.

At step 2801, first information is sent to a network device, the first information includes a first indicator, and the first indicator is used to indicate one or more usage case of one or more TOs.

In some embodiments, transmission of the first information is performed via a first channel. The first channel includes at least one of: a dynamic grant physical uplink shared channel (DG PUSCH); a configured grant physical uplink shared channel (CG PUSCH); or a physical uplink control channel (PUCCH).

In some embodiments, before sending the first information to the network device, the method further includes: receiving first configuration information sent by the network device, and the first configuration information is used to configure the first information.

In some embodiments, the first information includes a first indication field. The first indication field carries a first value, and the first value indicates that the first information sent by the network device includes the first indicator.

In some embodiments, the method further includes: receiving second configuration information sent by the network device, and the second configuration information is used to configure the first information to include the first indication field.

In some embodiments, the first information is sent on a TO of a first CG period, and the first CG period is a CG period used for transmission of relevant data of a predetermined service.

In some embodiments, the first information is sent on a first TO, and the first TO is a TO used for transmission of relevant data of a predetermined service.

In some embodiments, the predetermined service is an extended reality (XR) service.

In some embodiments, the first information is sent via a first transmission resource in a first channel, and the first transmission resource include any one or more predefined transmission resources in the first channel.

In some embodiments, he first information is scrambled using a first radio network temporary identifier (RNTI), and the first RNTI is a predefined RNTI used to scramble the first information including the first indicator.

In some embodiments, the method further includes: in a case where the first channel conflicts with at least one second channel, determining a priority of the first channel and a priority of the second channel, and the second channel is a channel without carrying the first information; sending the first information to the network device based on the priority of the first channel and/or the priority of the second channel.

In some embodiments, the second channel includes at least one of: a DG PUSCH; a CG PUSCH; or a PUCCH.

In some embodiments, the first channel conflicting with the second channel includes at least one of: a transmission resource of the first channel at least partially overlapping with a transmission resource of the second channel; or a transmission resource carrying the first information in the first channel at least partially overlapping with a transmission resource of the second channel.

In some embodiments, the priority of the first channel is determined based on a predefined protocol; or the priority of the first channel is configured by the network device to the terminal; or the priority of the first channel is determined by the terminal.

In some embodiments, sending the first information to the network device based on the priority of the first channel and/or the priority of the second channel includes at least one of:
discarding the second channel in a case where the priority of the first channel is higher than the priority of the second channel; or
discarding the first channel in a case where the priority of the first channel is lower than the priority of the second channel;
discarding the second channel in a case where the priority of the first channel is equal to the priority of the second channel;
multiplexing the second channel into the first channel in a case where the priority of the first channel is equal to the priority of the second channel;
discarding the first channel in a case where the priority of the first channel is equal to the priority of the second channel;
discarding the second channel in a case where the priority of the first channel is equal to the priority of the second channel and a transmission resource in the first channel that conflicts with the second channel includes a transmission resource carrying the first information;
discarding a transmission resource in the first channel that conflicts with the second channel in a case where the priority of the first channel is equal to the priority of the second channel and the transmission resource in the first channel that conflicts with the second channel includes a transmission resource without carrying the first information;
discarding the second channel in a case where the priority of the first channel is a first priority;
discarding the second channel in a case where the priority of the first channel is a first priority, and a transmission resource in the first channel that conflicts with the second channel includes a transmission resource carrying the first information;
discarding the first channel in a case where the priority of the first channel is a second priority; or
discarding the first channel in a case where the priority of the first channel is a second priority and a transmission resource in the first channel that conflicts with the second channel includes a transmission resource carrying the first information.

In some embodiments, the first priority is higher than the second priority.

In some embodiments, the first information includes CG uplink control information (UCI).

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

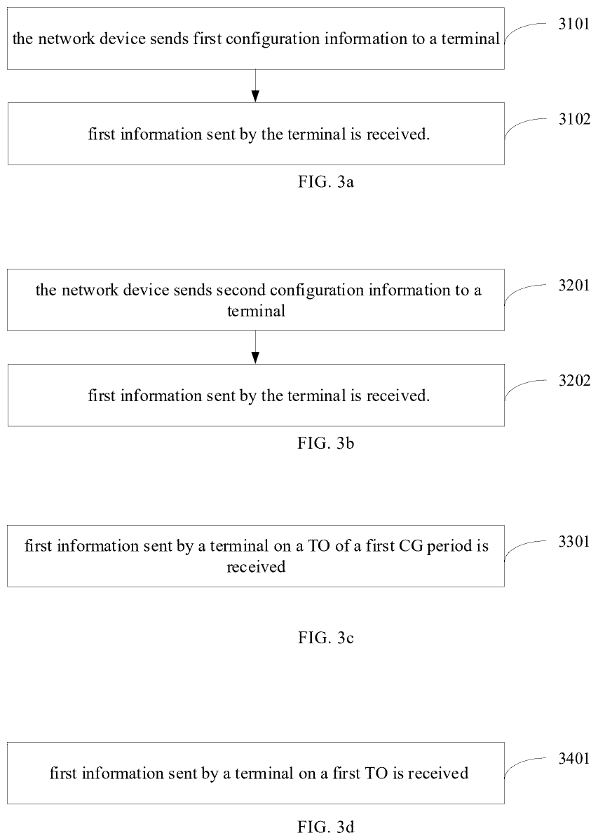

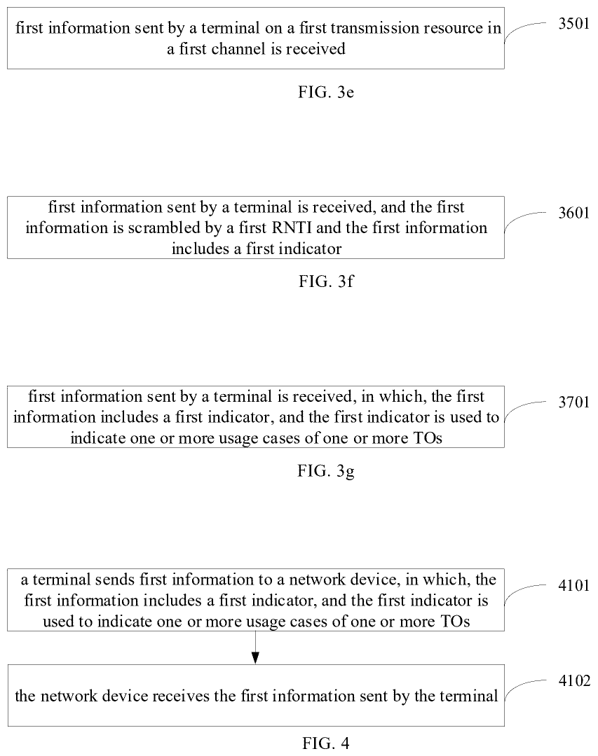

FIG. 3a is a flowchart of an information transmission method provided by an embodiment of the present disclosure. As shown in FIG. 3a, an embodiment of the present disclosure relates to an information transmission method. The method is performed by a network device 102 and includes the following steps.

At step 3101, the network device sends first configuration information to a terminal.

At step 3102, first information sent by the terminal is received.

In an example, in a case where the first configuration information configures the first information to include the first indicator, the first information including the first indicator sent by the terminal is received. In a case where the first configuration information configures the first information without including the first indicator, the first information without including the first indicator sent by the terminal is received.

For a detailed description of steps 3101-3102, reference can be made to the embodiment of FIG. 2a.

The information transmission method involved in the embodiment of the present disclosure may include at least one of step S3101 to step S3102. For example, step S3101 may be implemented as an independent embodiment, and step S3102 may be implemented as an independent embodiment, which is not limited thereto.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 3b is a flowchart of an information transmission method provided by an embodiment of the present disclosure. As shown in FIG. 3b, an embodiment of the present disclosure relates to an information transmission method. The method is performed by a network device 102 and includes the following steps.

At step 3201, the network device sends second configuration information to a terminal.

At step 3202, first information sent by the terminal is received.

In an example, in a case where a first indication field of the first information carries a first value, it is determined that the first information sent by the terminal includes the first indicator. In a case where the first indication field of the first information carries a first value, it is determined that the first information sent by the terminal includes the first indicator.

For a detailed description of steps 3201-3202, reference can be made to the embodiment of FIG. 2b above.

The information transmission method involved in the embodiment of the present disclosure may include at least one of step S3201 to step S3202. For example, step S3201 may be implemented as an independent embodiment, and step S3202 may be implemented as an independent embodiment, which is not limited thereto.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 3c is a flowchart of an information transmission method provided by an embodiment of the present disclosure. As shown in FIG. 3c, an embodiment of the present disclosure relates to an information transmission method. The method is performed by a network device 102 and includes the following steps.

At step 3301, first information sent by a terminal on a TO of a first CG period is received.

In an example, in a case where the first information is sent on the TO in the first CG period, it indicates that the first information includes the first indicator. In a case where the first information is sent on a TO in a period other than the first CG period, it indicates that the first information does not include the first indicator, that is, the first information including the first indicator sent by the terminal on the TO in the first CG period is received and the first information without including the first indicator sent by the terminal on the TO in the period other than the first CG period is received.

For a detailed description of step 3301, reference can be made to the embodiment of FIG. 2c above.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 3d is a flowchart of an information transmission method provided by an embodiment of the present disclosure. As shown in FIG. 3d, an embodiment of the present disclosure relates to an information transmission method. The method is performed by a network device 102 and includes the following steps.

At step 3401, first information sent by a terminal on a first TO is received.

In an example, in a case where the first information is sent on the first TO, it indicates that the first information includes the first indicator. In a case where the first information is sent on a TO other than the first TO, it indicates that the first information does not include the first indicator, that is, the first information including the first indicator sent by the terminal on the first TO is received, and the first information without including the first indicator sent by the terminal on the TO other than the first TO is received.

For a detailed description of step 3401, reference can be made to the embodiment of FIG. 2d above.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 3e is a flowchart of an information transmission method provided by an embodiment of the present disclosure. As shown in FIG. 3e, an embodiment of the present disclosure relates to an information transmission method. The method is performed by a network device 102 and includes the following step.

At step 3501, first information sent by a terminal on a first transmission resource in a first channel is received.

In an example, in a case where the first information is sent on the first transmission resource in the first channel, it indicates that the first information includes the first indicator. In a case where the first information is sent on a transmission resource other than the first transmission resource in the first channel, it indicates that the first information does not include the first indicator, that is, the first information including the first indicator sent by the terminal on the first transmission resource in the first channel is received, and the first information without including the first indicator sent by the terminal on the transmission resource other than the first transmission resource in the first channel is received.

For a detailed description of step 3501, reference can be made to the above-mentioned embodiment of FIG. 2e.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 3f is a flowchart of an information transmission method provided by an embodiment of the present disclosure. As shown in FIG. 3f, an embodiment of the present disclosure relates to an information transmission method. The method is performed by a network device 102 and includes the following steps.

At step 3601, first information sent by a terminal is received, and the first information is scrambled by a first RNTI and the first information includes a first indicator.

In an example, in a case where the first information is scrambled by the first RNTI, it indicates that the first information includes the first indicator. In a case where the first information is scrambled by a second RNTI, it indicates that the first information does not include the first indicator. That is, the first information including the first indicator scrambled by the first RNTI and sent by the terminal is received, and the first information without including the first indicator scrambled by the second RNTI and sent by the terminal is received.

For a detailed description of step 3601, reference can be made to the embodiment of FIG. 2f above.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 3g is a flowchart of an information transmission method provided by an embodiment of the present disclosure. As shown in FIG. 3g, an embodiment of the present disclosure relates to an information transmission method. The method is performed by a network device 102 and includes the following steps.

At step 3701, first information sent by a terminal is received. The first information includes a first indicator, and the first indicator is used to indicate one or more usage cases of one or more TOs.

In some examples, the method includes: receiving the first information sent by the terminal, in which, the first information includes the first indicator, and the first indicator is used to indicate the one or more usage cases of the one or more Tos.

In some examples, transmission of the first information is performed via a first channel.

The first channel includes at least one of: a DG PUSCH; a CG PUSCH; or a PUCCH.

In some examples, before receiving the first information sent by the terminal, the method further includes: sending first configuration information to the terminal, in which, the first configuration information is used to configure the first information.

In some examples, the first information includes a first indication field, and the first indication field carries a first value, and the first value indicates that the first information sent by the network device includes the first indicator.

In some examples, the method further includes: sending second configuration information to the terminal, and the second configuration information is used to configure the first information to include the first indication field.

In some examples, the first information is sent on a TO of a first CG period, and the first CG period is a CG period used for transmission of relevant data of a predetermined service.

In some examples, the first information is sent on a first TO, and the first TO is a TO used for transmission of relevant data of a predetermined service.

In some examples, the predetermined service is an extended reality (XR) service.

In some examples, the first information is sent via a first transmission resource in a first channel, and the first transmission resource includes any one or more predefined transmission resources in the first channel.

In some examples, the first information is scrambled using a first radio network temporary identifier (RNTI), and the first RNTI is a predefined RNTI used to scramble the first information including the first indicator.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

FIG. 4 is a flowchart of an information transmission method according to an embodiment of the present disclosure. As shown in FIG. 4, an embodiment of the present disclosure relates to an information transmission method. The method is configured in a communication system 100, and includes the following steps.

At step 4101, a terminal sends first information to a network device, in which, the first information includes a first indicator, and the first indicator is used to indicate one or more usage cases of one or more TOs.

At step 4102, the network device receives the first information sent by the terminal.

For an optional implementation of step 4101 and an optional implementation of step 4102, reference can be made to the description of the above embodiment, and details may not be described herein.

In some embodiments, the above method may include the method of the embodiments of the above communication system side, the terminal side, the network device side, etc., and details may not be described herein.

In the implementation or embodiment, unless there is any contradiction, each step can be independent, arbitrarily combined or exchanged in order, the optional implementations or optional examples can be arbitrarily combined, and can be arbitrarily combined with other implementations or other embodiments.

The present disclosure also relates to an information transmission method, performed by the network device 102. The information transmission method may include: determining that the first information includes a first indicator.

In an example, determining that the first information includes the first indicator specifically includes: determining that the first information includes the first indicator based on at least one of first configuration information, second configuration information, a CG period for sending the first information, a TO for sending the first information, a transmission resource for sending the first information, and a RNTI for scrambling the first information.

In an example, determining, based on the second configuration information, that the first information includes the first indicator specifically includes: determining that the first information includes the first indicator based on a value carried in a first indication field of the first information.

For a detailed description of the above contents, reference can be made to the aforementioned embodiment description.

The present disclosure also relates to an information transmission method, which is performed by the network device 102. The information transmission method may include: after receiving the first information, processing the first information in a first manner, in which, the first manner is: a processing manner corresponding to information including the first indicator. For a detailed description of this part of the content, reference can be made to the description of the above embodiment.

The present disclosure also relates to an information transmission method, which is performed by the network device 102. The information transmission method may include: receiving second information, in which, the second information does not include the first information; and processing the second information in a second manner, in which, the second manner is: a processing manner corresponding to information without including the first indicator.

In an example, the second information herein may be understood as the “first information without including the first indicator” mentioned in the aforementioned embodiment. For detailed introduction of this part, reference can be made to description of the aforementioned embodiment.

The following is an illustrative introduction for the above method.

### Optional Embodiment 1

In an implementation, a base station configures at least one set of CG resources for a terminal on one BWP through RRC signaling. The terminal may perform uplink transmission on TOs in all CG configurations by itself within a CG period configured by the base station. In another implementation, the base station configures partial information of the at least one set of CG configurations for the terminal on one BWP through the RRC signaling, and the base station notifies the terminal of remaining information of the CG configurations through dynamic signaling DCI. After the base station activates the CG configurations through dynamic signaling DCI, the terminal may perform uplink transmission on TOs in the CG configurations by itself within the CG period configured by the base station.

The terminal performs uplink transmission in a valid TO and notifies the base station of a usage case of the TO through dynamic indication information, and a notification method is based on UCI. There are two usage cases, one of which is “unused” and the other one of which is “used”. The terminal may not use a TO in an “unused” state, or the terminal may not use the TO in the “unused” state until the dynamic indication information is updated. The terminal may not use a TO in a “used” state. The UCI is a new UCI or a CG UCI, which is carried by a CG PUSCH, and sent in any one or several of the TOs.

Based on the above, in a case where the UCI carrying the dynamic indication information is the CG UCI, the information field in the CG UCI is reused or reinterpreted. The manner in which the information field is reused or reinterpreted includes at least one of the following solutions.

### Option 1: RRC Signaling Configuration, Explicit Indication

In an embodiment, the base station notifies the terminal of understanding of the information field in the CG UCI through RRC signaling RE-purposes. RE-purposes may be optionally configured as {baseline, Rel-18base}. When the RRC signaling is configured as baseline, the information field in the CG UCI is understood according to the existing mechanism (Rel-15\16\17). Some channels and signal processing procedures related to the CG UCI are also processed according to the existing mechanism. When the RRC signaling is configured with Rel-18base, the information field in the CG UCI is understood according to Rel-18. Some channels and signal processing procedures related to the CG UCI are also processed according to the Rel-18 mechanism.

For example, when RE-purposes is configured as baseline, the CG UCI includes four fields: a HARQ process number, a redundancy version, a new data indicator, and COT sharing information. When RE-purposes is configured as Rel-18base, the CG UCI includes fields such as a dynamic information indication field.

### Option 2: CG-UCI Adds a Re-Purposes Indicator Field, Explicit Indication

In an embodiment, the CG UCI includes a re-purposes indication field. The indication field is used to indicate whether other fields in the CG UCI are understood according to the existing mechanism (Rel-15\16\17), or to indicate whether other fields in the CG UCI are understood according to the Rel-18 mechanism. The bitwidth of the indication field is 1, or the bitwidth of the indication field is 1 when the base station configures the first RRC signaling, otherwise the bitwidth of the indication field is 0.

For example, the re-purposes indication field takes a value of 0 or 1. In a case where the indication field in the CG UCI sent by the terminal is 0, the other fields in the CG UCI are understood according to the existing mechanism (Rel-15\16\17). In a case where the indication field in the CG UCI sent by the terminal is 1, the other fields in the CG UCI are understood according to the Rel-18 mechanism.

### Option 3: Base Station Configures a XR to Indicate a CG/TO, Implicit Indication

In an embodiment, the base station configures a XR_CG or a XR_TO for the terminal.

When the terminal sends a CG PUSCH in a TO in the XR_CG, and the CG PUSCH is multiplexed to carry the CG UCI, the field in CG UCI is understood according to the Rel-18 mechanism, otherwise the field in CG UCI is understood according to the existing mechanism (Rel-15\16\17).

When the terminal sends the CG PUSCH in the XR_TO, and the CG PUSCH is multiplexed to carry the CG UCI, the field in CG UCI is understood according to the Rel-18 mechanism, otherwise the field in CG UCI is understood according to the existing mechanism (Rel-15\16\17). Details are described in FIG. 2d2 above.

### Option 4: a CG UCI Multiplexes Different Resources in a CG PUSCH, Implicit Indication

In an embodiment, a protocol predefines that different resources of the CG UCI multiplexed in CG PUSCH correspond to different understandings for the information field.

For example, when CG UCI is multiplexed on the first three time field symbols, the information field is understood according to the Rel-18 mechanism, otherwise information field is understood according to the existing mechanism (Rel-15\16\17). Details are described in FIG. 2e2 above.

### Optional Embodiment 2

In an embodiment, a UCI carrying dynamic indication information is a new UCI or a CG UCI. A terminal notifies a base station of a usage case of a TO through the dynamic indication information, and the usage case includes two types of “unused” and “used”. The terminal may not use a TO in the “unused” state, or the terminal may not use the TO in the “unused” state until the dynamic indication information is updated. The terminal may not use a TO in the “used” state. The UCI is carried by a CG PUSCH or a DG PUSCH or a PUCCH and is sent in any one or several TOs. When a plurality of service channels of the terminal arrive simultaneously, the method for processing a channel of the UCI carrying the dynamic indication information includes at least one of the following solutions.

Optional 1: a Protocol Predefines that a Channel Carrying the UCI is a high priority

The protocol predefines that a first channel carrying the UCI is a channel with a high priority, such as a DG PUSCH with a high priority, a CG PUSCH with a high priority, or a PUCCH with a high priority. Specifically, the processing method includes at least one of:
in a case where the first channel carries the UCI, configured the first channel as a normal high-priority channel and following the existing priority conflict mechanism;
in a case where the first channel is the CG PUSCH and conflicts with a normal high-priority PUCCH, discarding the PUCCH;
in a case where the first channel is the DG PUSCH and conflicts with the normal high-priority PUCCH, discarding the PUCCH;
in a case where the first channel is the PUCCH and conflicts with the normal high-priority PUCCH, discarding the PUCCH;
in a case where the first channel is the CG PUSCH and conflicts with the normal high-priority PUCCH, multiplexing the PUCCH on the first channel;
in a case where the first channel is the DG PUSCH and conflicts with the normal high-priority PUCCH, multiplexing the PUCCH on the first channel;
in a case where the first channel is the PUCCH and conflicts with the normal high-priority PUCCH, discarding the first channel;
in a case where the first channel is the CG PUSCH, and a resource of the CG PUSCH carrying the UCI conflicts with the ordinary high-priority PUCCH, discarding the PUCCH;
in a case where the first channel is the CG PUSCH, and the resource without carrying the UCI conflicts with the ordinary high-priority PUCCH, discarding a part where the first channel CG PUSCH conflicts with the PUCCH;
in a case where the first channel is the DG PUSCH, and the resource of the CG PUSCH carrying the UCI conflicts with the ordinary high-priority PUCCH, discarding the PUCCH; or
in a case where the first channel is the DG PUSCH, and the resource without carrying the UCI conflicts with the ordinary high-priority PUCCH, discarding a part where the first channel DG PUSCH conflicts with the PUCCH.

### Optional 2: RRC Signaling Configuration

RRC signaling is ConflictSelection, and the RRC signaling is configured by the base station to the terminal and indicates at least two manners of processing a conflict for the first channel.

In an implementation, ConflictSelection takes values of {high, low}. When a value of ConflictSelection is configured as high, the first channel has a high priority and follows the existing priority conflict mechanism. When a value of ConflictSelection is configured as low, the first channel has a low priority and follows the existing priority conflict mechanism. When the RRC signaling is not configured, the first channel is defaulted to the high priority or the low priority and follows the existing priority conflict mechanism.

In another implementation, ConflictSelection takes values of {high, low}. When a value of ConflictSelection is configured as high, the first channel has the high priority and all channels/signals that conflict with the first channel are discarded. When a value of ConflictSelection is configured as low, the first channel has the low priority and follows the existing priority conflict mechanism. When the RRC signaling is not configured, the first channel is defaulted to the high priority or the low priority.

In another implementation, ConflictSelection takes values of {high, low}. When a value of ConflictSelection is configured as high, the first channel has the high priority and all channels/signals that conflict with the first channel are discarded. When a value of ConflictSelection is configured as low, the first channel has the low priority and once the channel conflicts with other channels/signals, the first channel is discarded. When the RRC signaling is not configured, the first channel is defaulted to the high priority or the low priority.

In another implementation, ConflictSelection takes values of {high, low}. When a value of ConflictSelection is configured as high, the first channel has the high priority and all channels/signals that conflict with a resource of the first channel carrying the UCI are discarded. When a value of ConflictSelection is configured as low, the first channel has the low priority and follows the existing priority conflict mechanism. When the RRC signaling is not configured, the first channel is defaulted to the high priority or the low priority.

In another implementation, ConflictSelection takes values of {high, low}. When a value of ConflictSelection is configured as high, the first channel has a high priority and all channels/signals that conflict with the resource of the first channel carrying the UCI are discarded. When a value of ConflictSelection is configured as low, the first channel has the low priority and once the resource of the channel carrying the UCI conflicts with other channels/signals, the first channel is discarded. When the RRC signaling is not configured, the first channel is defaulted to the high priority or the low priority.

The conflict between two or more channels mentioned in the above Optional 1 and Optional 2 can also be described as an overlap between two or more time domain resources, frequency domain resources, or time-frequency domain resources, where the overlap include a partial overlap and an all overlap.

The embodiments of the present disclosure also propose an apparatus for implementing any of the above methods, for example, an apparatus is proposed, the above apparatus includes units or modules for implementing various steps performed by the terminal in any of the above methods. For another example, an apparatus is proposed, including units or modules for implementing various steps performed by a network device (such as an access network device, a core network function node, a core network device, etc.) in any of the above methods.

It should be understood that the division of the units or modules in the above apparatus is only a division of logical functions, and in an actual implementation, they may be fully or partially integrated into one physical entity, or they may be physically separated. In addition, the units or modules in the apparatus can be implemented in the form of a processor calling software: for example, the apparatus includes a processor, the processor is connected to a memory, and instructions are stored in the memory. The processor calls the instructions stored in the memory to implement any of the above methods or implement the functions of the units or modules of the above apparatus. The processor is, for example, a general-purpose processor, such as a central processing unit (CPU) or a microprocessor, and the memory is a memory inside the device or a memory outside the device. Alternatively, the units or modules in the apparatus can be implemented in the form of hardware circuits, and the functions of some or all of the units or modules can be realized by designing the hardware circuits. The above hardware circuits can be understood as one or more processors. For example, in one implementation, the above hardware circuit is an application-specific integrated circuit (ASIC), and the functions of some or all of the above units or modules are realized by designing the logical relationship of the components in the circuit. For example, in another implementation, the above hardware circuit can be realized by a programmable logic device (PLD), taking a field programmable gate array (FPGA) as an example, which can include a large number of logic gate circuits, and the connection relationship between the logic gate circuits is configured by a configuration file, so as to realize the functions of some or all of the above units or modules. All units or modules of the above apparatuses can be realized in the form of a processor calling software, or in the form of a hardware circuit, or in part by a processor calling software, and the rest by a hardware circuit.

In the embodiments of the present disclosure, the processor is a circuit with a signal processing capability. In one implementation, the processor may be a circuit with an instruction reading and running capability, such as a central processing unit (CPU), a microprocessor, a graphics processing unit (GPU) (which may be understood as a microprocessor), or a digital signal processor (DSP), etc. In another implementation, the processor may realize certain functions through the logical relationship of the hardware circuit, and the logical relationship of the above hardware circuit is fixed or reconfigurable, such as a hardware circuit implemented by a processor as an application-specific integrated circuit (ASIC) or a programmable logic device (PLD), such as an FPGA. In a reconfigurable hardware circuit, the processor loads a configuration document to implement the process of hardware circuit configuration, which may be understood as the process of the processor loading instructions to implement the functions of some or all of the above units or modules. In addition, it may also be a hardware circuit designed for artificial intelligence, which may be understood as an ASIC, such as a neural network processing unit (NPU), a tensor processing unit (TPU), a deep learning processing unit (DPU), etc.

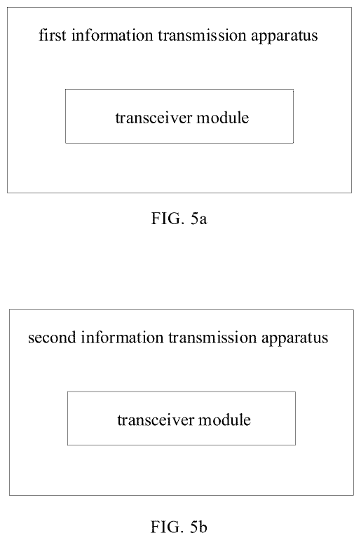

FIG. 5a is a structural schematic diagram of a first information transmission apparatus provided by an embodiment of the disclosure. As shown in FIG. 5a, the first information transmission apparatus 6100 includes a transceiver module, configured to send first information to a network device, in which, the first information includes a first indicator, and the first indicator is used to indicate one or more usage cases of one or more TOs. Optionally, the above-mentioned determining module is used to execute the steps related to “determining the sending resource corresponding to the first information” performed by the terminal 101 in any of the above methods, and details will not be repeated here.

FIG. 5b is a structural schematic diagram of a second information transmission apparatus provided by an embodiment of the disclosure. As shown in FIG. 5b, the second information transmission apparatus 6200 includes a transceiver module, configured to receive first information sent by a terminal, in which, the first information includes a first indicator, and the first indicator is used to indicate one or more usage cases of one or more TOs. Optionally, the above-mentioned sending module is used to execute the steps related to “configuring the sending resource corresponding to the first information for the terminal” performed by the network device 102 in any of the above methods, and details will not be repeated here.

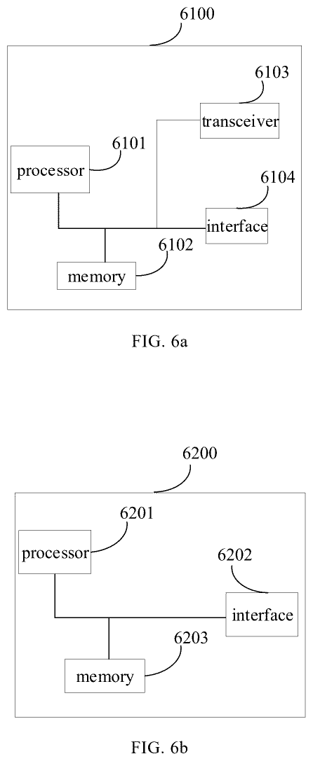

FIG. 6a is a schematic diagram of a communication device 6100 proposed in an embodiment of the present disclosure. The communication device 6100 may be a network device (e.g., an access network device, a core network device, etc.), or a terminal (e.g., a user equipment, etc.), or a chip, a chip system, or a processor that supports a network device to implement any of the above methods, or a chip, a chip system, or a processor that supports a terminal to implement any of the above methods. The communication device 6100 may be used to implement the method described in the above method embodiments, and for details, reference may be made to the description in the above method embodiments.

As shown in FIG. 6a, the communication device 6100 includes one or more processors 6101. The processor 6101 may be a general-purpose processor or a dedicated processor, for example, a baseband processor or a central processing unit. The baseband processor may be used to process a communication protocol and communication data, and the central processing unit may be used to control the communication device (such as a base station, a baseband chip, a terminal, a terminal chip, a DU or a CU, etc.) to execute a program and process data of the program. The processor 6101 is used to call instructions so that the communication device 6100 executes any of the above methods.

In some embodiments, the communication device 6100 further includes one or more memories 6102 for storing instructions. Optionally, all or part of the memory 6102 may be outside the communication device 6100.

In some embodiments, the communication device 6100 further includes one or more transceivers 6103. When the communication device 6100 includes one or more transceivers 6103, the communication steps such as sending and receiving in the above methods are performed by the transceiver 6103, and the other steps are performed by the processor 6101.

In some embodiments, the transceiver may include a receiver and a transmitter, and the receiver and the transmitter may be separate or integrated. Optionally, the terms such as “transceiver”, “transceiver unit”, “transceiver machine”, “transceiver circuit”, etc. may be exchangeable with each other, the terms such as “transceiver”, “transceiver unit”, “transceiver machine”, “transceiver circuit”, etc. may be exchangeable with each other, and the terms such as “receiver”, “receiving unit”, “receiver”, “receiving circuit”, etc. may be exchangeable with each other.

Optionally, the communication device 6100 further includes one or more interface circuits 6104, which are connected to the memory 6102. The interface circuit 6104 may be used to receive signals from the memory 6102 or other apparatuses, and may be used to send signals to the memory 6102 or other apparatuses. For example, the interface circuit 6104 may read instructions stored in the memory 6102 and send the instructions to the processor 6101.

The communication device 6100 described in the above embodiments may be a network device or a terminal, but the scope of the communication device 6100 described in the present disclosure is not limited thereto, and the structure of the communication device 6100 may not be limited by FIG. 6a. The communication device may be an independent device or may be part of a larger device. For example, the communication device may be: 1) an independent integrated circuit (IC), or a chip, or a chip system or subsystem; (2) a collection of one or more ICs, optionally, the above IC collection may also include a storage component for storing data and programs; (3) an ASIC, such as a modem; (4) a module that can be embedded in other devices; (5) a receiver, a terminal, an intelligent terminal, a cellular phone, a wireless device, a handheld device, a mobile unit, a vehicle-mounted device, a network device, a cloud device, an artificial intelligence device, etc.; (6) others, etc.

FIG. 6b is a schematic diagram of a chip 6200 proposed in an embodiment of the present disclosure. In case where the communication device 6100 may be a chip or a chip system, reference may be made to the schematic diagram of the chip 6200 shown in FIG. 6b, but the present disclosure is not limited thereto.

The chip 6200 includes one or more processors 6201, and the processor 6201 is used to call instructions so that the chip 6200 executes any of the above methods.

In some embodiments, the chip 6200 further includes one or more interface circuits 6202, which are connected to the memory 6203. The interface circuit 6202 may be used to receive signals from the memory 6203 or other apparatuses, and the interface circuit 6202 may be used to send signals to the memory 6203 or other apparatuses. For example, the interface circuit 6202 may read instructions stored in the memory 6203 and send the instructions to the processor 6201. Optionally, the terms such as “interface circuit”, “interface”, “transceiver pin”, and “transceiver” may be exchangeable with each other.

In some embodiments, the chip 6200 further includes one or more memories 6203 for storing instructions. Optionally, all or part of the memory 6203 may be outside the chip 6200.

The present disclosure also proposes a storage medium, on which instructions are stored, and when the instructions are executed on the communication device 6100, the communication device 6100 executes any of the above methods. Optionally, the storage medium is an electronic storage medium. Optionally, the storage medium is a computer-readable storage medium, but is not limited to thereto, and it may also be a storage medium readable by other apparatuses. Optionally, the storage medium may be a non-transitory storage medium, but is not limited to thereto, and it can also be a temporary storage medium.

The present disclosure also proposes a program product, which, when executed by the communication device 6100, enables the communication device 6100 to execute any of the above methods. Optionally, the program product is a computer program product.

The present disclosure also proposes a computer program, which, when executed on a computer, causes the computer to execute any one of the above methods.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general-purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art understand that “first”, “second”, or other various numerical numbers involved in the disclosure are only described for the convenience of differentiation, and are not used to limit the scope of the embodiments of the disclosure, or used to indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

Corresponding relationships indicated by tables in the present disclosure may be configured or predefined. Values of information in the tables are only examples, and may be configured as other values, which are not limited in the disclosure. When the corresponding relationship between information and parameters is configured, it is not always necessary to configure all corresponding relationships indicated in tables. For example, in the tables of the present disclosure, corresponding relationships indicated by some rows may not be configured. For another example, appropriate transformations and adjustments, such as splitting and merging, may be made based on the above tables. Names of parameters shown in headers of the tables may be other names understandable by the communication apparatus, and values or representations of the parameters may be other values or representations understandable by the communication apparatus. When the above tables are implemented, other data structures may be used, for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solutions. Those skilled in the art may adopt different methods for each specific application to implement the described functions, but such implementation should not be considered as going beyond the scope of the present disclosure.

Those skilled in the art may clearly understand that, a specific working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be contained within the protection scope of the present disclosure. Therefore, the protection scope of the disclosure shall be subject to the protection scope of claims.

1. An information transmission method, performed by a terminal, comprising:
sending first information to a network device, wherein the first information comprises a first indicator, and the first indicator indicates one or more usage cases of one or more transmission occasions (TOs).

2. The method according to claim 1, wherein transmission of the first information is performed via a first channel;
the first channel comprises at least one of:
a dynamic grant physical uplink shared channel (DG PUSCH);
a configured grant physical uplink shared channel (CG PUSCH); or
a physical uplink control channel (PUCCH).

3. The method according to claim 1, wherein, before sending the first information to the network device, the method further comprises:
receiving first configuration information sent by the network device, wherein the first configuration information is used to configure the first information to comprise the first indicator.

4. (canceled)

5. The method according to claim 4, further comprising:
receiving second configuration information sent by the network device, wherein the second configuration information is used to configure the first information to comprise the first indication field.

6. The method according to claim 1, wherein the first information comprises a first indication field, and the first indication field indicates that the first information comprises the first indicator; or
wherein the first information is sent on a TO of a first CG period, and the first CG period is a CG period used for transmission of relevant data of a predetermined service; or
wherein the first information is sent on a first TO, and the first TO is a TO used for transmission of relevant data of a predetermined service; or
wherein the first information is sent via a first transmission resource in a first channel, and the first transmission resource comprises any one or more predefined transmission resources in the first channel; or
wherein the first information is scrambled using a first radio network temporary identifier (RNTI), and the first RNTI is a predefined RNTI used to scramble the first information comprising the first indicator.

7-10. (canceled)

11. The method according to claim 1, further comprising:
determining a priority of a first channel and a priority of a second channel, wherein the second channel is a channel without carrying the first information, and the first channel conflicts with at least one second channel;
sending the first information to the network device based on at least one of the priority of the first channel or the priority of the second channel.

12. The method according to claim 11, wherein the second channel comprises at least one of:
a DG PUSCH;
a CG PUSCH; or
a PUCCH; or
wherein the first channel conflicting with the second channel comprises at least one of: a transmission resource of the first channel at least partially overlapping with a transmission resource of the second channel; or a transmission resource carrying the first information in the first channel at least partially overlapping with a transmission resource of the second channel; or
wherein the priority of the first channel is determined based on a predefined protocol, or configured by the network device to the terminal, or determined by the terminal.

13-14. (canceled)

15. The method according to claim 11, wherein sending the first information to the network device based on at least one of the priority of the first channel or the priority of the second channel comprises at least one of:
discarding the second channel in a case where the priority of the first channel is higher than the priority of the second channel; or
discarding the first channel in a case where the priority of the first channel is lower than the priority of the second channel;
discarding the second channel in a case where the priority of the first channel is equal to the priority of the second channel;
multiplexing the second channel into the first channel in a case where the priority of the first channel is equal to the priority of the second channel;
discarding the first channel in a case where the priority of the first channel is equal to the priority of the second channel;
discarding the second channel in a case where the priority of the first channel is equal to the priority of the second channel and a transmission resource in the first channel that conflicts with the second channel comprises a transmission resource carrying the first information;
discarding a transmission resource in the first channel that conflicts with the second channel in a case where the priority of the first channel is equal to the priority of the second channel and the transmission resource in the first channel that conflicts with the second channel comprises a transmission resource without carrying the first information;
discarding the second channel in a case where the priority of the first channel is a first priority;
discarding the second channel in a case where the priority of the first channel is a first priority, and a transmission resource in the first channel that conflicts with the second channel comprises a transmission resource carrying the first information;
discarding the first channel in a case where the priority of the first channel is a second priority; or
discarding the first channel in a case where the priority of the first channel is a second priority and a transmission resource in the first channel that conflicts with the second channel comprises a transmission resource carrying the first information.

16-17. (canceled)

18. An information transmission method, performed by a network device, comprising:
receiving first information sent by a terminal, wherein the first information comprises a first indicator, and the first indicator indicates one or more usage cases of one or more transmission occasions (TOs).

19. The method according to claim 18, wherein transmission of the first information is performed via a first channel;
the first channel comprises at least one of:
a dynamic grant physical uplink shared channel (DG PUSCH);
a configured grant physical uplink shared channel (CG PUSCH); or
a physical uplink control channel (PUCCH).

20. The method according to claim 18, wherein, before receiving the first information sent by the terminal, the method further comprises:
sending first configuration information to the terminal, wherein the first configuration information is used to configure the first information to comprise the first indicator.

21. (canceled)

22. The method according to claim 18, further comprising:
sending second configuration information to the terminal, wherein the second configuration information is used to configure the first information to comprise the first indication field.

23. The method according to claim 18, wherein the first information comprises a first indication field, and the first indication field indicates that the first information comprises the first indicator;
wherein the first information is sent on a TO of a first CG period, and the first CG period is a CG period used for transmission of relevant data of a predetermined service; or
the first information is sent on a first TO, and the first TO is a TO used for transmission of relevant data of a predetermined service; or
wherein the first information is sent via a first transmission resource in a first channel, and the first transmission resource comprises any one or more predefined transmission resources in the first channel; or
wherein the first information is scrambled using a first radio network temporary identifier (RNTI), and the first RNTI is a predefined RNTI used to scramble the first information comprising the first indicator.

24-27. (canceled)

28. The method according to claim 18, further comprising:
determining that the first information comprises the first indicator.

29. The method according to claim 28, wherein determining that the first information comprises the first indicator comprises:
determining that the first information comprises the first indicator based on at least one of first configuration information, second configuration information, a CG period for sending the first information, a TO for sending the first information, a transmission resource for sending the first information, and a RNTI for scrambling the first information.

30. The method according to claim 29, wherein determining, based on the second configuration information, that the first information comprises the first indicator comprises:
determining that the first information comprises the first indicator based on a value carried in a first indication field of the first information.

31. The method according to claim 18, wherein, after receiving the first information, the method further comprises:
processing the first information in a first manner, wherein the first manner is a processing manner corresponding to information comprising the first indicator.

32. The method according to claim 31, further comprising:
receiving second information, wherein the second information does not comprise the first information;
processing the second information in a second manner, wherein the second manner is different from the first manner, and the second manner is a processing manner corresponding to information without comprising the first indicator.

33. A first information transmission apparatus, comprising:
one or more processor, configured to send first information to a network device, wherein the first information comprises a first indicator, and the first indicator indicates one or more usage cases of one or more transmission occasions (TOs).

34. A second information transmission apparatus, configured to perform the method according to claim 18.

35-37. (canceled)
